(19) United States
(12) Patent Application Publication
(10) Pub. No.: US 2009/0142516 A1
(43) Pub. Date: Jun. 4, 2009

(54) CELLULOSE ACYLATE FILM AND METHOD FOR PRODUCING SAME, RETARDATION FILM, POLARIZER, AND LIQUID CRYSTAL DISPLAY DEVICE

(75) Inventor: Yasuyuki Sasada, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Minato-ku (JP)

(21) Appl. No.: 12/272,079

(22) Filed: Nov. 17, 2008

(30) Foreign Application Priority Data
Nov. 15, 2007 (JP) 2007-296550

(51) Int. Cl. C09K 19/02; C08B 3/00

(52) U.S. Cl. 428/1.31; 536/63

(57) ABSTRACT

A method for producing a cellulose acylate film, comprising heat-treating a cellulose acylate film having a haze, at a temperature T (unit, ° C.) satisfying the condition of the following formula (I):

Tc≦T<Tm₀ (I)

wherein Tc means the crystallization temperature (unit, ° C.) of the cellulose acylate film before the heat treatment;
Tm₀ means the melting point (unit, ° C.) of the cellulose acylate film before the heat treatment.

### BACKGROUND OF THE INVENTION

1. Field of the Invention

The present invention relates to a cellulose acylate film having optical anisotropy, hardly cracking and capable of directly sticking to a polarizing film, and to its production method, and also relates to a retardation film, a polarizer and a liquid crystal display device comprising the cellulose acylate film.

2. Background Art

A polymer film of typically cellulose ester, polyester, polycarbonate, cycloolefin polymer, vinylic polymer, polyimide or the like is used in silver halide photographic materials, retardation films, polarizers and liquid crystal display devices. These polymers are widely employed for films for optical use, as capable of forming films more excellent in point of surface smoothness and uniformity.

Of those, a cellulose acylate film having a suitable moisture permeability can be stuck online directly to a most popular polarizing film comprising polyvinyl alcohol (PVA)/iodine. Accordingly, in particular, cellulose acetate is widely employed as a protective film for polarizer, and various methods for its production are investigated (for example, see JP-A 2001-188128 and JP-A 2000-352620).

On the other hand, in case where a cellulose acylate film is used in optical applications for retardation films, supports for retardation films, protective films for polarizers, and liquid crystal display devices, control of its optical anisotropy is an extremely important element in determination of the properties (e.g., visibility) of display devices. With the recent requirement for enlarging the viewing angle of liquid crystal display devices, improvement of retardation compensation has become desired, and it is thereby desired to suitably control the in-plane retardation (Re—this may be hereinafter referred to simply as “Re”) and the thickness-direction retardation (Rth—this may be hereinafter referred to simply as “Rth”) of the retardation film to be disposed between a polarizing film and a liquid crystal cell. In particular, as a compensation film for IPS-mode liquid crystal display or for VA-mode (Vertically Aligned mode) liquid crystal display, preferably useful for a liquid crystal TV, it is desired to produce a cellulose acylate film having large Re in a simplified manner. For producing the film of the type, various methods have been investigated, such as a method of heat treating a cellulose acylate film (for example, see JP-A 2007-84804 and JP-A 2007-86755), a method of stretching a cellulose acylate film with a lot of residual solvent amount (for example, see JP-A 2005-104148), a method of adding an retardation-increasing agent (for example, see EP-0911656-A2), a method of stretching a cellulose acylate film with a little residual solvent amount (for example, see JP-A 2006-83203).

However, direct heat treatment or stretching of a film formed from a cellulose acylate could not result in efficient expression of film retardation while keeping the haze of the film low. Specifically, when a formed cellulose acylate film is heat-treated directly as it is, like in JP-A 2007-84804 and JP-A 2007-86755, then the retardation control is insufficient; and when the film is stretched at a high draw ratio like in JP-A 2005-104148, EP-0911656-A2 and JP-A 2006-83203, then the haze of the film increases. It has been found that, when the film of the type is incorporated into a liquid-crystal display device, then the former case is problematic in that it results in significant color shift and contrast reduction in viewing angle change, and the latter case is problematic in that it results in contrast reduction irrespective of viewing angle change.

In addition, it has been further found that the film produced through heat treatment of a cellulose acylate resin has a micro-slow axis angle distribution, and this causes a problem of contrast reduction in liquid-crystal display devices.

Accordingly, for solving the problems in the prior art and for solving the above-mentioned new problems with heat-treated films, the present inventor has investigated the condition of the cellulose acylate film itself to be used. A first object of the invention is to provide a method for producing a cellulose acylate film having a low haze and having an efficiently expressed retardation, by heat treatment of a cellulose acylate film; to provide a method for producing a cellulose acylate film having a small micro-slow axis angle distribution; and in particular to provide a method for producing a cellulose acylate film having a low haze and an efficiently expressed retardation, and having a small micro-slow axis angle distribution. A second object of the invention is to provide the cellulose acylate film produced according to the production method. A third object of the invention is to provide a cellulose acylate film having a quantity of melting heat and a quantity of crystallization heat (ΔHm) each falling within a specific range and having a small micro-slow axis angle distribution. A fourth object of the invention is to provide a cellulose acylate film favorably obtained according to the production method. A fifth object of the invention is to provide a retardation film, a polarizer and a liquid-crystal display device each comprising the cellulose acylate film.

### SUMMARY OF THE INVENTION

The present inventor has assiduously studied and, as a result, have found that pre-treatment for haze increase of a cellulose acylate film followed by heat treatment thereof within a temperature range of from Tc to Tm₀ may bring about expression of a larger retardation of the film treated under the same heat treatment condition while reducing the haze thereof, and may further bring about reduction in the micro-slow axis angle distribution of the treated film. The inventor has further found that, even when the film is stretched, its haze can be still reduced, its retardation expression can be kept large and its micro-slow axis angle distribution can be reduced. The inventor has further found out the condition of a specifically-prepared cellulose acylate film for use in the production method for the intended cellulose acylate film of the invention. Specifically, as a means for solving the problems, the inventor has provided the present invention described in detail hereinunder.

[1] A method for producing a cellulose acylate film, comprising heat-treating a cellulose acylate film having a haze, at a temperature T (unit, ° C.) satisfying the condition of the following formula (I):

Tc≦T≦Tm₀ (I)

wherein Tc means the crystallization temperature (unit, ° C.) of the cellulose acylate film before the heat treatment;
Tm₀ means the melting point (unit, ° C.) of the cellulose acylate film before the heat treatment.

[1-1] The method for producing a cellulose acylate film of [1], wherein the difference (HZ₁-HZ₀) between the haze (HZ₀) of the cellulose acylate film before the heat treatment step and the haze (HZ₁) of the cellulose acylate film after the heat treatment step is at least 0.05%.

[2] The method for producing a cellulose acylate film of [1] or [1-1], wherein the haze-having cellulose acylate film contains fine particles in an amount of from 0 to 7.5% by mass relative to the cellulose acylate.

[3] The method for producing a cellulose acylate film of any one of [1] to [2], further comprising pre-stretching a cellulose acylate film to prepare the cellulose acylate film having a haze.

[3-1] The method for producing a cellulose acylate film of [3], wherein the temperature in pre-stretching is from (Tg−20) to (Tg+50)° C.

[3-2]The method for producing a cellulose acylate film of [3] or [3-1], wherein the residual solvent amount in the cellulose acylate film before pre-stretching is at most 5.0% by mass.

[3-3] The method for producing a cellulose acylate film of anyone of [3] to [3-2], wherein the draw ratio in the pre-stretching is from 1 to 300%.

[3-4] The method for producing a cellulose acylate film of any one of [3] to [3-3], wherein the drawing speed in the pre-stretching is from 10 to 10,000%/min.

[3-5] The method for producing a cellulose acylate film of any one of [1.] to [3-4], wherein the film is stretched in the cross direction (in the film width direction) after the heat treatment.

[3-6] The method for producing a cellulose acylate film of any one of [3] to [3-5], wherein the cellulose acylate, the main ingredient constituting the cellulose acylate film before pre-stretching satisfies the following formula (II):

2.70<SA+SB≦3.00 (II)

wherein SA means a degree of substitution with an acetyl group of the hydroxyl group in cellulose;
SB means a degree of substitution with an acyl group having at least 3 carbon atoms, of the hydroxyl group in cellulose.

[3-7] The method for producing a cellulose acylate film of any one of [3] to [3-6], wherein the cellulose acylate, the main ingredient constituting the cellulose acylate film before pre-stretching satisfies the following formula (III):

0<SB≦2.0 (III)

wherein SB means a degree of substitution with an acyl group having at least 3 carbon atoms, of the hydroxyl group in cellulose.

[3-8] The method for producing a cellulose acylate film of any one of [3] to [3-7], wherein in the pre-stretching, a cellulose acylate film having a haze value of less than 0.5% is pre-stretched to give a cellulose acylate film having a haze value of at least 0.5%.

[4] The method for producing a cellulose acylate film of any one of [1] to [3-8], wherein the heat treatment is attained until the haze value of the cellulose acylate film lowers by at least 0.05% relative to the haze value of the cellulose acylate film before the heat treatment.

[4-1] The method for producing a cellulose acylate film of any one of [1] to [4], wherein the obtained film is stretched (re-stretched) after the heat treatment.

[4-2] The method for producing a cellulose acylate film of [4-1], wherein the haze value of the re-stretched cellulose acylate film is at most 1.0%.

[5] A cellulose acylate film having a quantity of crystallization heat of at most 2.0 J/g, a quantity of melting heat (ΔHm) of more than 0 J/g, and a micro-slow axis angle distribution of at most 3°.

[6] A cellulose acylate film produced according to the production method of any one of [1] to [5].

[7] The cellulose acylate film of [6], having a quantity of crystallization heat of at most 2.0 J/g, a quantity of melting heat (ΔHm) of more than 0 J/g, and a micro-slow axis angle distribution of at most 3°.

[7-1] The cellulose acylate film of any one of [5] to [7] having an in-plane retardation value (Re, unit: nm) of at least 40 nm.

[7-2] The cellulose acylate film of any one of [5] to [7-1] having Nz of the following formula (IV) of from 0 to 1.

Nz=(nx−nz)/(nx−ny) (IV)

wherein nx, means the refractive index of the film in the in-plane slow axis (x) direction thereof;

ny means the refractive index of the film in the direction perpendicular to the in-plane x direction thereof;
nz means the refractive index of the film in the thickness-direction (in the in-plane normal direction) thereof;
the slow axis is in the direction in which the in-plane refractive index of the film is the largest.

[7-3] The cellulose acylate film of [5] to [7-1], having Nz represented by the above formula (IV) of from more than 1 to 20.

[7-4] The cellulose acylate film of anyone of [7-1] to [7-3], having an in-plane retardation value (Re, unit: nm) of at least 50 nm.

[8] A cellulose acylate film containing fine particles in an amount of from 0 to 7.5% by mass added thereto relative to the cellulose acylate and having a haze value of at least 1.5%.

[9] The cellulose acylate film of [8], having a haze value of from 1.5% to less than 25%.

[9-1] The cellulose acylate film of [8] or [9] of such that the ratio of the sound wave velocity through the film in the direction in which the sound wave velocity is the maximum to the sound wave velocity in the direction perpendicular to that direction is from 1.05 to 10.0.

[10] A retardation film having at least one cellulose acylate film of any one of [5] to [7-4].

[11] A polarizer having at least one cellulose acylate film of any one of [6] to [7-4].

[12] A liquid crystal display device having at least one cellulose acylate film of any one of [5] to [7-4], retardation film of [10] or polarizer of [11].

[12-1] A liquid-crystal display device having at least one cellulose acylate film of [7-2] or [7-4], of which the display mode is an IPS mode.

[12-2] A liquid-crystal display device having at least one cellulose acylate film of [7-1], [7-3] or [7-4], of which the display mode is a VA mode.

[13] A polarizer having at least one cellulose acylate film of [9] or [9-1].

[14] A liquid-crystal display device having at least one cellulose acylate film of [9] or [9-1] or polarizer of [10].

[15] An image display device having at least one cellulose acylate film of [9] or [9-1].

According to the production method of the invention, the haze of the cellulose acylate film produced can be reduced, the retardation thereof can be expressed more highly, and the micro-slow axis angle distribution thereof can be reduced even when the film is heat-treated and preferably stretched under the same condition. The retardation film, the polarizer, the liquid-crystal display device and the image display device produced by the use of the cellulose acylate film, of which the haze and the retardation are controlled to be on a predetermined level according to the production method of the invention, have excellent optical properties. The retardation film, the polarizer, the liquid-crystal display device and the image display device produced by the use of the cellulose acylate film, of which the micro-slow axis angle distribution is controlled to be on a predetermined level according to the production method of the invention, have excellent optical properties.

### BEST MODE FOR CARRYING OUT THE INVENTION

The method for producing a cellulose acylate film and others of the invention are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### <<Method for Producing Cellulose Acylate Film>>

The method for producing a cellulose acylate film of the invention (hereinafter this may be referred to as the production method of the invention) comprises a step of heat treatment of a cellulose acylate film having a haze, at a temperature T (unit: ° C.) satisfying the condition of the following formula (I):

Tc≦T≦Tm₀ (I)

wherein Tc means the crystallization temperature (unit, ° C.) of the cellulose acylate film before the heat treatment; Tm₀ means the melting point (unit, ° C.) of the cellulose acylate film before the heat treatment.

In this, “having a haze” means that the haze of the film, as measured according to the measuring method described below in this description, is at least 0.4%. The production method of the invention is described below.

### [Cellulose Acylate]

Cellulose acylate for use in the method of producing the cellulose acylate film of the invention is described.

The cellulose acylate film to be heat-treated in the production method of the invention is a film of such that the polymer as the main ingredient constituting the film is a cellulose acylate. The “polymer as the main ingredient” as referred to herein means, in case where the film is formed of a single polymer, the polymer, or means, in case where the film is formed of plural polymers, the polymer having the highest mass fraction of the constitutive polymers.

The cellulose acylate is an ester of cellulose with a carboxylic acid. In the cellulose acylate, all or a part of the hydrogen atoms of the hydroxyl groups existing at the 2-, 3- and 6-positions of the glucose unit constituting the cellulose are substituted with an acyl group. Examples of the acyl group are acetyl, propionyl, butyryl, isobutyryl, pivaloyl, heptanoyl, hexanoyl, octanoyl, decanoyl, dodecanoyl, tridecanoyl, tetradecanoyl, hexadecanoyl, octadecanoyl, cyclohexanecarbonyl, oleoyl, benzoyl, naphthylcarbonyl and cinnamoyl. The acyl group is preferably acetyl, propionyl, butyryl, dodecanoyl, octadecanoyl, pivaloyl, oleoyl, benzoyl, naphthylcarbonyl or cinnamoyl, most preferably acetyl, propionyl or butyryl.

The cellulose ester may be an ester of cellulose with different acids. The cellulose acylate may be substituted with different acyl groups.

For the cellulose acylate film manufactured according to the producing method of the invention, expression in Re and humidity dependency of the retardation are controlled by controlling SA and, SB. The SA and SB represent a substitution degree of acetyl group (having 2 carbon atoms) which are substituted for hydroxyl group of cellulose of cellulose acylate and a substitution degree of acyl group having 3 or more carbon atoms which are substituted for hydroxyl group of cellulose, respectively. Even more, Tc is also controlled by them and the heat treatment temperature is thereby controlled. The humidity dependency of the retardation is retardation variation according to the humidity.

In accordance with the necessary optical properties of the film of the invention, the cellulose acylate film produced according to the production method of the invention, SA+SB is suitably controlled. In general, 2.50<SA+SB≦3.00, preferably 2.70<SA+SB≦3.00, more preferably 2.88≦SA+SB≦3.00, even more preferably 2.89≦SA+SB≦2.99, still more preferably 2.90≦SA+SB≦2.98, further more preferably 2.92≦SA+SB≦2.97. Increasing SA+SB brings about improving the film formability and at the same time, Re of the film obtained after heat treatment at a heat treatment temperature set higher than (Tc+20)° C. may be enlarged and the humidity dependence of the retardation of the film may be reduced. The film of the type is favorably used especially in IPS-mode liquid-crystal display devices. On the other hand, when SA+SB is lowered, then Re of the re-stretched film may be enlarged after heat treatment attained at a heat treatment temperature between Tc and (Tc+20)° C.; and the film of the type is especially preferred for VA-mode liquid-crystal display devices.

By controlling SB, the humidity dependence of the retardation of the cellulose acylate film produced according to the production method of the invention may be controlled. By increasing SB, the humidity dependence of the retardation of the film may be reduced, and the glass transition temperature and the melting point of the film may lower. In consideration of the balance between the humidity dependence of retardation of the film and the lowering of the glass transition temperature and the melting point thereof, the range of SB is preferably 0<SB≦2.0, more preferably 0.1<SB≦1.0, even more preferably 0.2≦SB≦0.7. In case where all the hydroxyl groups of cellulose are substituted, the above mentioned degree of substitution is 3. Further, when the degree of 2-acyl substitution in the glucose unit is represented by DS2, the degree of 3-acyl substitution is by DS3, and the degree of 6-acyl substitution is by DS6, then DS6/(DS2+DS3+DS6) is preferably at least 0.32, more preferably at least 0.322, even more preferably from 0.324 to 0.340.

The Cellulose ester is possible to be synthesized by a known method.

Regarding a method for synthesizing cellulose acylate, its basic principle is described in Wood Chemistry by Nobihiko Migita et al., pp. 180-190 (Kyoritsu Publishing, 1968). One typical method for synthesizing cellulose acylate is a liquid-phase acylation method with carboxylic acid anhydride-carboxylic acid-sulfuric acid catalyst. Concretely, a starting material for cellulose such as cotton linter or woody pulp is pretreated with a suitable amount of a carboxylic acid such as acetic acid, and then put into a previously-cooled acylation mixture for esterification to synthesize a complete cellulose acylate (in which the overall substitution degree of acyl group in the 2-, 3- and 6-positions is nearly 3.00). The acylation mixture generally includes a carboxylic acid serving as a solvent, a carboxylic acid anhydride serving as an esterifying agent, and sulfuric acid serving as a catalyst. In general, the amount of the carboxylic acid anhydride to be used in the process is stoichiometrically excessive over the overall amount of water existing in the cellulose that reacts with the carboxylic acid anhydride and that in the system.

Next, after the acylation, the excessive carboxylic acid anhydride still remaining in the system is hydrolyzed, for which, water or water-containing acetic acid is added to the system. Then, for partially neutralizing the esterification catalyst, an aqueous solution that contains a neutralizing agent (e.g., carbonate, acetate, hydroxide or oxide of calcium, magnesium, iron, aluminium or zinc) may be added thereto. Then, the resulting complete cellulose acylate is saponified and ripened by keeping it at 20 to 90° C. in the presence of a small amount of an acylation catalyst (generally, sulfuric acid remaining in the system), thereby converting it into a cellulose acylate having a desired substitution degree of acyl group and a desired polymerization degree. At the time when the desired cellulose acylate is obtained, the catalyst still remaining in the system is completely neutralized with the above-mentioned neutralizing agent; or the catalyst therein is not neutralized, and the cellulose acylate solution is put into water or diluted acetic acid (or water or diluted acetic acid is put into the cellulose acylate solution) to thereby separate the cellulose acylate, and thereafter this is washed and stabilized to obtain the intended product, cellulose acylate.

Preferably, the polymerization degree of the cellulose acylate is 150 to 500 as the viscosity-average polymerization degree thereof, more preferably 200 to 400, even more preferably 220 to 350. The viscosity-average polymerization degree may be measured according to a description of limiting viscosity method by Uda et al. (Kazuo Uda, Hideo Saito; Journal of the Fiber Society of Japan, vol. 18, No. 1, pp. 105-120, 1962). The method for measuring the viscosity-average polymerization degree is described also in JP-A-9-95538.

Cellulose acylate where the amount of low-molecular components is small may have a high mean molecular weight (polymerization degree), but its viscosity may be lower than that of ordinary cellulose acylate. Such cellulose acylate where the amount of low-molecular components is small may be obtained by removing low-molecular components from cellulose acylate synthesized in an ordinary method. The removal of low-molecular components may be attained by washing cellulose acylate with a suitable organic solvent. Cellulose acylate where the amount of low-molecular components is small may be obtained by synthesizing it. In case where cellulose acylate where the amount of low-molecular components is small is synthesized, it is desirable that the amount of the sulfuric acid catalyst in acylation is controlled to be 0.5 to 25 parts by mass relative to 1.00 parts by mass of cellulose. When the amount of the sulfuric acid catalyst is controlled to fall within the range, then cellulose acylate having a preferable molecular weight distribution (uniform molecular weight distribution) can be synthesized. The polymerization degree and the distribution of the molecular weight of the cellulose acylate can be measured by the gel penetration chromatography (GPC), etc.

The starting material, cotton for cellulose ester and methods for synthesizing it are described also in Hatsumei Kyokai Disclosure Bulletin (No. 2001-1745, issued on Mar. 15, 2001, Hatsumei Kyokai), pp. 7-12.

The cellulose acylate to be used as the starting material in producing the cellulose acylate film may be a powdery or granular one, or may also be pelletized one. The water content of the cellulose acylate to be used as the starting material is preferably at most 1.0% by mass, more preferably at most 0.7% by mass, most preferably at most 0.5% by mass. As the case may be, the water content is preferably at most 0.2% by mass. In case where the water content of the cellulose acylate is not within the preferred range, it is desirable that the cellulose acylate is dried with dry air or by heating and then used in the invention.

In producing the cellulose acylate film, one or more different types of polymers may be used either singly or as combined.

### [Cellulose Acylate Solution]

The cellulose acylate film used for the production method of the invention (hereinafter, also referred to as “cellulose acylate film before heat treatment” in this description) may be manufactured, for example, from a cellulose acylate solution that contains the cellulose acylate and various additives, according to a method of solution casting film formation. Here in after, the cellulose acylate solution used in the method of solution casting film formation is described.

### (Solvent)

The main solvent of the cellulose acylate solution to be used in manufacturing the cellulose acylate film used for the production method of the invention is preferably an organic solvent that is a good solvent for the polymer. The organic solvent of the type is preferably one having a boiling point of not higher than 80° C. from the viewpoint of reducing the load in drying. More preferably, the organic solvent has a boiling point of 10 to 80° C., even more preferably 20 to 60° C. As the case may be, an organic solvent having a boiling point of 30 to 45° C. may also be preferably used for the main solvent.

The main solvent includes halogenohydrocarbons, esters, ketones, ethers, alcohols and hydrocarbons, which may have a branched structure or acyclic structure. The main solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom). Regarding the main solvent of the cellulose acylate solution to be used in manufacturing the cellulose acylate film used for the production method of the invention, when the solvent of the solution is a single solvent, then it is the main solvent, but when the solvent is a mixed solvent of different solvents, then the main solvent is the solvent having the highest mass fraction of all the constitutive solvents.

Halogenohydrocarbon can be exemplified as a preferable main solvent.

The halogenohydrocarbon is preferably a chlorohydrocarbon, including dichloromethane and chloroform, and dichloromethane is more preferred.

The ester includes, for example, methyl formate, ethyl formate, methyl acetate, and ethyl acetate.

The ketone includes, for example, acetone, methyl ethyl ketone.

The ether includes, for example, diethyl ether, methyl tert-butyl ether, diisopropyl ether, dimethoxymethane, 1,3-dioxolan, 4-methyldioxolan, tetrahydrofuran, methyltetrahydrofuran, and 1,4-dioxane.

The alcohol includes, for example, methanol, ethanol, and 2-propanol.

The hydrocarbon includes, for example, n-pentane, cyclohexane, n-hexane, benzene, and toluene.

The organic solvent that may be combined with the main solvent includes halogenohydrocarbons, esters, ketones, ethers, alcohols and hydrocarbons, which may have a branched structure or a cyclic structure. The organic solvent may have any two or more functional groups of esters, ketones, ethers and alcohols (i.e., —O—, —CO—, —COO—, —OH). Further, hydrogen atoms in the hydrocarbon part of these esters, ketones, ethers and alcohols may be substituted with a halogen atom (especially, fluorine atom).

The halogenohydrocarbon is preferably a chlorohydrocarbon, including dichloromethane and chloroform, and dichloromethane is more preferred.

The ester includes, for example, methyl formate, ethyl formate, propyl formate, pentyl formate, methyl acetate, ethyl acetate, and pentyl acetate.

The ketone includes, for example, acetone, methyl ethyl ketone, diethyl ketone, diisobutyl ketone, cyclopentanone, cyclohexanone, and methylcyclohexanone.

The ether includes, for example, diethyl ether, methyl tert-butyl ether, diisopropyl ether, dimethoxymethane, dimethoxyethane, 1,4-dioxane, 1,3-dioxolan, 4-methyldioxolan, tetrahydrofuran, methyltetrahydrofuran, anisole, and phenetole.

The alcohol includes, for example, methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, and 2,2,3,3-tetrafluoro-1-propanol. The alcohol having 1-4 carbon atoms is preferred, and methanol, ethanol or butanol is more preferred, and methanol or butanol is most preferred.

The hydrocarbon includes, for example, n-pentane, cyclohexane, n-hexane, benzene, toluene, and xylene.

The organic solvent having two or more different types of functional groups includes, for example, 2-ethoxyethyl acetate, 2-methoxyethanol, 2-butoxyethanol, and methyl acetacetate.

As the polymer that constitutes the cellulose acylate film of the invention includes hydrogen combined functional groups such as a hydroxyl group, ester and ketone, then it is desirable that the total solvent for it contains 5% to 30% by mass, more preferably 7% to 25% by mass, even more preferably 10% to 20% by mass of alcohol from the viewpoint of reducing the load for film peeling from a support.

The expressibility of Re and Rth of the cellulose acylate film manufactured by the production method of the invention can be easily adjusted by adjusting the content of alcohol. Specifically, a temperature of heat treatment can be relatively decreased and the achievement range of the Re and Rth can be more increased, by increasing the content of alcohol.

The cellulose acylate solution to be used for manufacturing the cellulose acylate film used for the production method of the invention is preferably so designed that the content of the organic solvent therein which has a boiling point of 95° C. or higher and is not therefore so much evaporated away along with halogenohydrocarbon in the initial drying stage but is gradually concentrated therein and is a poor solvent for cellulose ester is 1% to 15% by mass, more preferably 1.5% to 13% by mass, even more preferably 2% to 10% by mass. In the invention, it is also effective to add a small amount of water to the polymer solution for controlling the solution viscosity and for increasing the wet film strength in drying and further for increasing the dope strength in casting on drum; and for example, the water content may be from 0.1 to 5% by mass of the solution, more preferably from 0.1 to 3% by mass, even more preferably from 0.2 to 2% by mass.

Hereinunder described are preferred examples of a combination of organic solvents that are favorably used as a solvent for the cellulose acylate solution to be used in producing the cellulose acylate film for use in the production method of the invention, to which, however, the invention should not be limited. The numerical value for the ratio means part by mass.

(1) dichloromethane/methanol/ethanol/butanol=80/10/5/5
(2) dichloromethane/methanol/ethanol/butanol=80/5/5/10
(3) dichloromethane/isobutyl alcohol=90/10
(4) dichloromethane/acetone/methanol/propanol=80/5/5/10
(5) dichloromethane/methanol/butanol/cyclohexane=80/8/10/2
(6) dichloromethane/methyl ethyl ketone/methanol/butanol=80/10/5/5
(7) dichloromethane/butanol=90/10
(8) dichloromethane/acetone/methyl ethyl ketone/ethanol/butanol=68/10/10/7/5
(9) dichloromethane/cyclopentanone/methanol/pentanol=80/2/15/3
(10) dichloromethane/methyl acetate/ethanol/butanol=70/12/15/3
(11) dichloromethane/methyl ethyl ketone/methanol/butanol=80/5/5/10
(12) dichloromethane/methyl ethyl ketone/acetone/methanol/pentanol=50/20/15/5/10
(13) dichloromethane/1,3-dioxolane/methanol/butanol=70/15/5/10
(14) dichloromethane/dioxane/acetone/methanol/butanol 75/5/10/5/5
(15) dichloromethane/acetone/cyclopentanone/ethanol/isobutyl alcohol/cyclohexane=60/18/3/10/7/2
(16) dichloromethane/methyl ethyl ketone/acetone/isobutyl alcohol=70/10/10/10
(17) dichloromethane/acetone/ethyl acetate/butanol/hexane=69/10/10/10/1
(18) dichloromethane/methyl acetate/methanol/isobutyl alcohol=65/15/10/10
(19) dichloromethane/cyclopentanone/ethanol/butanol=85/7/3/5
(20) dichloromethane/methanol/butanol=83/15/2
(21) dichloromethane=100
(22) acetone/ethanol/butanol=80/15/5
(23) methyl acetate/acetone/methanol/butanol=75/10/10/5
(24) 1,3-dioxolane=100
(25) dichloromethane/methanol/butanol/water=85/18/1.5/0.5
(26) dichloromethane/acetone/methanol/butanol/water 87/5/5/2.5/0.5
(27) dichloromethane/methanol=92/8
(28) dichloromethane/methanol=90/10
(29) dichloromethane/methanol 87/13
(30) dichloromethane/ethanol=90/10

As the case where a non-halogen organic solvent may be the main solvent, a detailed description is given in Hatsumei Kyokai Disclosure Bulletin (No. 2001-1745, issued on Mar. 15, 2001, Hatsumei Kyokai).

### (Solution Concentration)

The cellulose acylate concentration in the cellulose acylate solution to be prepared is preferably 5% to 40% by mass, more preferably 10% to 30% by mass, most preferably 15% to 30% by mass.

The cellulose acylate concentration may be so controlled that it could be a predetermined concentration in the stage where cellulose acylate is dissolved in solvent. Or, a solution having a low concentration (e.g., 4% to 14% by mass) is previously prepared, and then it may be concentrated by evaporating the solvent from it. On the other hand, a solution having a high concentration is previously prepared, and it may be diluted. The cellulose acylate concentration in the solution may also be reduced by adding additive thereto.

### (Additive)

The polymer solution to be used for manufacturing the cellulose acylate film used for the production method of the invention may contain various liquid or solid additives in accordance with the application, in respective preparation steps. Examples of the additives are plasticizer (its preferred additional amount is 0.01 to 10% by mass of the polymer; the same shall apply hereunder), UV absorbent (0.001 to 1% by mass), fine particles having a mean particle size of 5 to 3000 nm (0.001 to 7.5% by mass), fluorine-containing surfactant (0.001 to 1% by mass), release agent (0.0001 to 1% by mass), antioxidant (0.0001 to 1% by mass), optical anisotropy-controlling agent (0.01 to 10% by mass), IR absorbent (0.001 to 1% by mass).

The optical anisotropy-controlling agent are organic compounds having a molecular weight of at most 3000, preferably those having both a hydrophilic part and a hydrophobic part. These compounds are aligned between the polymer chains, therefore changing the retardation of the cellulose acylate film. Combined with cellulose acylate that is especially preferably used in the invention, these compounds may improve the hydrophobicity of the film and may reduce the moisture-dependent change of the retardation thereof. When combined with the above-mentioned UV absorbent or the above-mentioned IR absorbent, they may effectively control the wavelength dependence of the retardation of the cellulose acylate film. The additives to be used in the cellulose acylate film of the invention are preferably those not substantially evaporating in the drying step.

Preferably used herein are optical anisotropy-controlling agents having an effect of not so much changing Rth of the film before heat treatment or lowering it, depending on the intended Re and Rth. Adding such additives may improve the mobility of the polymer molecules during heat treatment, and therefore the Re and the Rth expressibility of the cellulose acylate film produced according to the production method of the invention may be further controlled. Therefore, for example, when combined with an optical anisotropy-controlling agent such as a retardation-increasing agent, not only a cellulose acylate film satisfying Nz value 0 to 1, but also a cellulose acylate film satisfying Nz value less than 0 or Nz value more than 1 may be suitably produced.

From the viewpoint of reducing the humidity-dependent retardation change of the film, the amount of these additives to be added to the film is preferably larger, but with the increase in the amount to be added, there may occur some problems in that the glass transition temperature (Tg) of the cellulose acylate film may lower and the additives may evaporate away during the process of film production. Accordingly, in case where cellulose acetate which is preferably used in the invention is used as the polymer, then the amount of additives having the molecular weight of 3000 or less to be added is preferably in the range of 30% or less, more preferably 0.01% to 30% by mass, even more preferably in the range of 2% to 20% by mass relative to the polymer.

From the viewpoint of increasing Rth/Re, concretely, preferred is a compound having at least one aromatic ring, more preferably from 2 to 15 aromatic rings, even more preferably from 3 to 10 aromatic rings. The configuration of the atoms constituting the compound except the aromatic ring is preferably such that the atoms are near to the same plane as that of the aromatic ring; and in case where the compound has plural aromatic rings, then the aromatic rings are preferably so configured as to be near to one and the same plane. For selectively increasing Rth, the condition of the additive existing in the film is preferably such that the plane of the aromatic ring is in the direction parallel to the film plane. Examples of these compounds include “the retardation-increasing agent” described in JP-A 2004361936 pp. 6 to 38, and the compound Al having the following structure is particularly preferred.

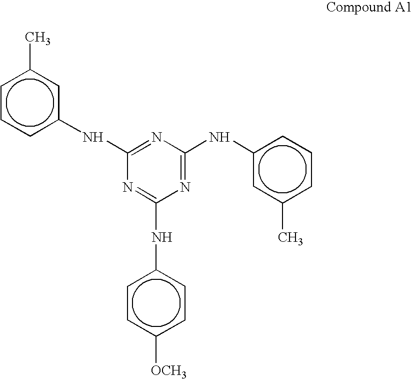

One or more different types of the additives may be used either singly or as combined.

For the additives which can be suitably used in case that cellulose acylate is used as a polymer of the invention, specifically, there can be exemplified described in JP-A-2005-104148 and in JP-A-2001-151901. For the IR absorbent, there can be exemplified described in JP-A-2001-194522. The time of adding the additives may be properly determined depending on the types of the additives.

In the invention, the following polymer plasticizer may be also preferably used as the additives.

The polymer plasticizer in the invention is characterized by having a repetitive unit in the compound. The polymer plasticizer for use in the invention has a number-average molecular weight of from 500 to 3000, preferably from 600 to 2800, more preferably from 700 to 2500, even more preferably from 700 to 2000. However, the polymer plasticizer in the invention is not limited to the compound having such a repetitive unit segment, but may be a mixture with a compound not having a repetitive unit.

The polymer plasticizer in the invention may be liquid or solid at the environment temperature or humidity at which it is used (in general, at room temperature, or that is, at 25° C. and relative humidity of 60%). Preferably, its color is as light as possible, and more preferably, it is colorless. Preferably, it is thermally stable at high temperatures, and more preferably its decomposition starting temperature is not lower than 150° C., even more preferably not lower than 200° C.

The polymer plasticizer for use in the invention is described in detail hereinunder with reference to its specific examples, to which, however, the polymer plasticizer for use in the invention should not be limited.

### (Type of Polymer Plasticizer)

Not specifically defined, the polymer plasticizer for use in the cellulose acylate film of the invention is preferably at least one plasticizer having a number-average molecular weight of at least 500 and selected from polyester plasticizers, polyether plasticizers, polyurethane plasticizers, polyester polyurethane plasticizers, polyester polyether plasticizers, polyether polyurethane plasticizers, polyamide plasticizers, polysulfone plasticizers, polysulfone amide plasticizers, and other polymer plasticizers mentioned below.

More preferably, at least one of them is any of polyester plasticizers, polyether plasticizers, polyurethane plasticizers, polyester polyurethane plasticizers, polyester polyether plasticizers, polyether polyurethane plasticizers, polyamide plasticizers, polysulfone plasticizers and polysulfone amide plasticizers, even more preferably any of polyester plasticizers, polyester polyurethane plasticizers and polyester polyether plasticizers. Preferred polymer plasticizers for use in the invention are described below according to their kinds.

### (Polyester Plasticizer)

The polyester plasticizer for use in the invention is described. Not specifically defined, the polyester plasticizer preferred for use in the invention is one produced through reaction of a dicarboxylic acid and a glycol, and both ends of the reaction product may be as such, or may be blocked by further reaction with a monocarboxylic acid or a monoalcohol. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 12 carbon atoms, or an aromatic dicarboxylic acid having from 8 to 12 carbon atoms.

The alkylenedicarboxylic acid component having from 4 to 12 carbon atoms preferred for the polyester plasticizer in the invention includes, for example, succinic acid, maleic acid, fumaric acid, glutaric acid, adipic acid, azelaic acid, sebacic acid, dodecanedicarboxylic acid, 1,4-cyclohexanedicarboxylic acid. The arylenedicarboxylic acid component having from 8 to 12 carbon atoms includes phthalic acid, terephthalic acid, 1,5-naphthalenedicarboxylic acid, 1,4-naphthalenedicarboxylic acid. One or more of these may be used either singly or as combined. The glycol for the polyester plasticizer is described. It includes an aliphatic or alicyclic glycol having from 2 to 12 carbon atoms, and an aromatic glycol having from 6 to 12 carbon atoms.

The aliphatic glycol and the alicyclic glycol having from 2 to 12 carbon atoms include ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol. One or more of these glycols may be used either singly or as combined.

Preferably, the polyester plasticizer in the invention is protected with a monoalcohol residue or a monocarboxylic acid residue in order that both ends of the polyester plasticizer are not a carboxylic acid. In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol, benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid. One or more of these may be used either singly or as combined.

Specific examples of preferred polyester plasticizers are poly(ethylene glycol/adipic acid) ester, poly(propylene glycol/adipic acid) ester, poly(1,3-butanediol/adipic acid) ester, poly(propylene glycol/sebacic acid) ester, poly(1,3-butanediol/sebacic acid) ester, poly(1,6-hexanediol/adipic acid) ester, poly(propylene glycol/phthalic acid) ester, poly(1,3-butanediol/phthalic acid) ester, poly(propylene glycol/terephthalic acid) ester, poly(propylene glycol/1,5-naphthalene-dicarboxylic acid) ester, poly (propylene glycol/terephthalic acid) ester of which both ends are blocked with 2-ethylhexyl alcohol ester, poly(propylene glycol/adipic acid) ester of which both ends are blocked with 2-ethylhexyl alcohol ester, and acetylated poly(butanediol/adipic acid) ester.

These polyesters may be readily produced in any ordinary methods. Concretely, for example, the above-mentioned dibasic acid or its alkyl ester is reacted with a glycol through polyesterification or interesterification according to a thermal fusion condensation method; or the acid chloride is reacted with a glycol according to an interfacial condensation method. The polyester plasticizers are described in detail in Koichi Murai, Plasticizers, Their Theory and Application, (by Miyuki Publishing, Mar. 1, 1973, 1st Edition). In addition, the materials described in JP-A 05-155809, 05-155810, 05-197073, 2006-259494, 07-330670, 2006-342227, 2007-003679 are also usable herein.

Commercial products are also usable. For example, Adeka's polyester plasticizers described in Diary 2007, pp. 5-27 (various types of Adekacizer P series, Adekacizer PN series are shown) are usable; Dai-Nippon Ink Chemical Industry's various commercial products of Polylight series described in List of Polymer-Related Commercial Products, 2007, p. 25 are usable; and Dai-Nippon Ink Chemical Industry's various commercial products of Polycizer series described in DIC's Polymer Modifiers (issued 1.4.2004, 000VIII), pp. 2-5 are usable. Further, US CP HALL's Plasthall P series are available. Velsicol Chemicals (Rosemont, Ill.) commercially sell benzoyl-functionalized polyethers as trade name of Benzoflex (e.g., Benzoflex 400, polypropylene glycol dibenzoate).

### (Polyester Polyether Plasticizer)

Next described are polyester polyether plasticizers for use in the invention. The polyester polyether plasticizers for use in the invention are condensed polymers of a dicarboxylic acid and a polyether diol. The dicarboxylic acid may be the aliphatic dicarboxylic acid having from 4 to 12 carbon atoms or the aromatic dicarboxylic acid having from 8 to 12 carbon atoms described in the above for polyester plasticizers.

The polyether having an aliphatic glycol with from 2 to 12 carbon atoms includes polyethylene ether glycol, polypropylene ether glycol, polytetramethylene ether glycol, and their combinations. Commercial polyether glycols that are typically usable herein are Carbowax resin, Pluornics resin and Niax resin. In producing the polyester polyether plasticizers for use in the invention, employable is any polymerization method well known to those skilled in the art.

Polyester polyether plasticizers described in U.S. Pat. No. 4,349,469 are usable herein. Basically, they are polyester polyether plasticizers produced from, for example, 1,4-cyclohexanedicarboxylic acid as a dicarboxylic acid component and 1,4-cyclohexanedimethanol and polytetramethylene ether glycol as a polyether component. Other useful polyester polyether plasticizers are commercial resins such as DuPont's Hytrel copolyesters, GAF's Galflex copolymers. For these, the materials described in JP-A 5-197073 are employable. Adeka's commercial products, Adekacizer RS series are usable herein. ICI Chemicals (Wilmington, Del.) commercially sell polyester ether plasticizers of alkyl-functionalized polyalkylene oxides as trade name of Pycal series (e.g., Pycal 94, polyethylene oxide phenyl ester).

### (Polyester Polyurethane Plasticizer)

Polyester polyurethane plasticizers for use in the invention are described. The plasticizers may be produced through condensation of a polyester with an isocyanate compound. The polyester may be the unblocked polyester described in the above for polyester plasticizers; and those described for polyester plasticizers are also preferably used herein.

The diisocyanate component to constitute the polyurethane structure includes OCN(CH₂)ₚNCO (p=2 to 8) polymethylene isocyanates such as typically ethylene diisocyanate, trimethylene diisocyanate, tetramethylene diisocyanate, hexamethylene diisocyanate; and aromatic diisocyanates such as p-phenylene diisocyanate, tolylene diisocyanate, p,p′-diphenylmethane diisocyanate, 1,5-naphthylene diisocyanate; and further m-xylylene diisocyanate, to which, however, the diisocyanate compound should not be limited. Of those, especially preferred are tolylene diisocyanate, m-xylylene diisocyanate, tetramethylene diisocyanate.

The polyester polyurethane plasticizers for use in the invention may be readily produced in an ordinary method in which starting compounds, a polyester diol and a diisocyanate are mixed and stirred under heat. For these, the materials described in JP-A 5-197073, 2001-122979, 2004-175971, 2004-175972 may be used.

### (Other Polymer Plasticizers)

In the invention, not only the above-mentioned polyester plasticizers, polyester polyether plasticizers and polyester polyurethane plasticizers, but also any other polymer plasticizers are usable. The other polymer plasticizers are aliphatic hydrocarbon polymers; alicyclic hydrocarbon polymers; acrylic polymers such as polyacrylates and polymethacrylates (in which the ester group is, for example, a methyl group, an ethyl group, a propyl group, a butyl group, an isobutyl group, a pentyl group, a hexyl group, a cyclohexyl group, an octyl group, a 2-ethylhexyl group, a nonyl group, an isononyl group, a tert-nonyl group, a dodecyl group, a tridecyl group, a stearyl group, an oleyl group, a benzyl group, a phenyl group); vinylic polymers such as polyvinyl isobutyl ether, poly-N-vinylpyrrolidone; styrenic polymers such as polystyrene, poly-4-hydroxystyrene; polyethers such as polyethylene oxide, polypropylene oxide; and polyamides, polyurethanes, polyureas, phenol/formaldehyde condensates, urea/formaldehyde condensates, polyvinyl acetate, etc.

These polymer plasticizers may be homopolymers comprising one type of a repetitive unit, or may be copolymers comprising plural types of repetitive structures. Two or more of the above polymers may be used, as combined. These polymer plasticizers may be used either alone or as combined; and in any case, they may exhibit the same effect. Of those, preferred are polyacrylates, polymethacrylates and their copolymers with any other vinyl monomer. Especially preferred are polymer plasticizers basically comprising acrylic polymers such as polyacrylates and polymethacrylates (in which the ester group is a methyl group, an ethyl group, a propyl group, a butyl group, a hexyl group, a cyclohexyl group, a 2-ethylhexyl group, an isononyl group, an oleyl group).

### (Specific Examples of Polymer Plasticizers)

Preferred specific examples of polymer plasticizers are described below; however, the polymer plasticizers usable in the invention should not be limited to these.

PP-1: Condensate of ethanediol/succinic acid (1/1 by mol) (number-average molecular weight 2500)
PP-2: Condensate of 1,3-propanediol/glutaric acid (1/1 by mol) (number-average molecular weight 1500)
PP-3: Condensate of 1,3-propanediol/adipic acid (1/1 by mol) (number-average molecular weight 1300)
PP-4: Condensate of 1,3-propanediol/ethylene glycol/adipic acid (1/1/2 by mol) (number-average molecular weight 1500)
PP-5: Condensate of 2-methyl-1,3-propanediol/adipic acid (1/1 by mol) (number-average molecular weight 1200)
PP-6: Condensate of 1,4-butanediol/adipic acid (1/1 by mol) (number-average molecular weight 1500)
PP-7: Condensate of 1,4-cyclohexanediol/succinic acid (1/1 by mol) (number-average molecular weight 800)
PP-8: Condensate of 1,3-propanediol/succinic acid (1/1 by mol) blocked with butyl ester at both ends (number-average molecular weight 1300)
PP-9: Condensate of 1,3-propanediol/glutaric acid (1/1 by mol) blocked with cyclohexyl, ester at both ends (number-average molecular weight 1500)
PP-10: Condensate of ethanediol/succinic acid (1/1 by mol) blocked with 2-ethylhexyl ester at both ends (number-average molecular weight 3000)
PP-11: Condensate of 1,3-propanediol/ethylene glycol/adipic acid (1/1/2 by mol) blocked with isononyl ester at both ends (number-average molecular weight 1500)
PP-12: Condensate of 2-methyl-1,3-propanediol/adipic acid (1/1 by mol) blocked with propyl ester at both ends (number-average molecular weight 1300)
PP-13: Condensate of 2-methyl-1,3-propanediol/adipic acid (1/1 by mol) blocked with 2-ethylhexyl ester at both ends (number-average molecular weight 1300)
PP-14: Condensate of 2-methyl-1,3-propanediol/adipic acid (1/1 by mol) blocked with isononyl ester at both ends (number-average molecular weight 1300)
PP-15: Condensate of 1,4-butanediol/adipic acid (1/1 by mol) blocked with butyl ester at both ends (number-average molecular weight 1800)
PP-16: Condensate of ethanediol/terephthalic acid (1/1 by mol) (number-average molecular weight 2000)
PP-17: Condensate of 1,3-propanediol/1,5-naphthalenedicarboxylic acid (1/1 by mol) (number-average molecular weight 1500)
PP-18: Condensate of 2-methyl-1,3-propanediol/isophthalic acid (1/1 by mol) (number-average molecular weight 1200)
PP-19: Condensate of 1,3-propanediol/terephthalic acid (1/1 by mol) blocked with benzyl ester at both ends (number-average molecular weight 1500)
PP-20: Condensate of 1,3-propanediol/1,5-naphthalenedicarboxylic acid (1/1 by mol) blocked with propyl ester at both ends (number-average molecular weight 1500)
PP-21: Condensate of 2-methyl-1,3-propanediol/isophthalic acid (1/1 by mol) blocked with butyl ester at both ends (number-average molecular weight 1200)
PP-22: Condensate of poly(mean degree of polymerization 5)propylene ether glycol/succinic acid (1/1 by mol) (number-average molecular weight 1800)
PP-23: Condensate of poly (mean degree of polymerization 3) ethylene ether glycol/glutaric acid (1/1 by mol) (number-average molecular weight 1600)
PP-24: Condensate of poly(mean degree of polymerization 4)propylene ether glycol/adipic acid (1/1 by mol) (number-average molecular weight 2200)
PP-25: Condensate of poly(mean degree of polymerization 4)propylene ether glycol/phthalic acid (1/1 by mol) (number-average molecular weight 1500)
PP-26: Condensate of poly(mean degree of polymerization 5)propylene ether glycol/succinic acid (1/1 by mol) blocked with butyl ester at both ends (number-average molecular weight 1900)
PP-27: Condensate of poly (mean degree of polymerization 3) ethylene ether glycol/glutaric acid (1/1 by mol) blocked with 2-ethylhexyl ester at both ends (number-average molecular weight 1700)
PP-28: Condensate of poly(mean degree of polymerization 4)propylene ether glycol/adipic acid (1/1 by mol) blocked with tert-nonyl ester at both ends (number-average molecular weight 1300)
PP-29: Condensate of poly(mean degree of polymerization 4)propylene ether glycol/phthalic acid (1/1 by mol) blocked with propyl ester at both ends (number-average molecular weight 1600)
PP-29′: Condensate of ethanediol/adipic acid (1/1 by mol) (number-average molecular weight 1000)
PP-30: Polyester urethane compound produced through condensation of 1,3-propanediol/succinic acid (1/1 by mol) condensate (number-average molecular weight 1500) with trimethylene diisocyanate (1 mol)
PP-31: Polyester urethane compound produced through condensation of 1,3-propanediol/glutaric acid (1/1 by mol) condensate (number-average molecular weight 1200) with tetramethylene diisocyanate (1 mol)
PP-32: Polyester urethane compound produced through condensation of 1,3-propanediol/adipic acid (1/1 by mol) condensate (number-average molecular weight 1000) with p-phenylene diisocyanate (1 mol)
PP-33: Polyester urethane compound produced through condensation of 1,3-propanediol/ethylene glycol/adipic acid (1/1/2 by mol) condensate (number-average molecular weight 1500) with tolylene diisocyanate (1 mol)
PP-34: Polyester urethane compound produced through condensation of 2-methyl-1,3-propanediol/adipic acid (1/1 by mol) condensate (number-average molecular weight 1200) with m-xylylene diisocyanate (1 mol)
PP-35: Polyester urethane compound produced through condensation of 1,4-butanediol/adipic acid (1/1 by mol) condensate (number-average molecular weight 1500) with tetramethylene diisocyanate (1 mol)
PP-36: Polyisopropyl acrylate (number-average molecular weight 1300)
PP-37: Polybutyl acrylate (number-average molecular weight 1300)
PP-38: Polyisopropyl methacrylate (number-average molecular weight 1200)
PP-39: Poly(methyl methacrylate/butyl methacrylate) (8/2 by mol) (number-average molecular weight 1600)
PP-40: Poly(methyl methacrylate/2-ethylhexyl methacrylate) (9/1 by mol) (number-average molecular weight 1600)
PP-41: Poly(vinyl acetate) (number-average molecular weight 2400)

### (Fine Particles)

The type of the fine particles for use in the cellulose acylate film of the invention is not specifically defined, for which, for example, preferred are inorganic substances and/or organic substances mentioned below, and one or more of these may be used either singly or as combined. Preferably, the fine particles are powdery.

For example, the inorganic substance for inorganic particles for use herein includes silicon dioxide, titanium oxide, aluminium oxide, aluminium hydroxide, tin oxide, zinc oxide, calcium carbonate, barium sulfate, talc, kaolin, calcium sulfate, etc.; and the organic particles may be formed of acrylic resin, organic silicone resin, polystyrene, urea resin, formaldehyde condensate, polymethacrylic acid methyl acrylate resin, acrylstyrene resin, polymethyl methacrylate resin, silicone resin, polystyrene resin, polycarbonate resin, benzoguanamine resin, melamine resin, polyolefin resin, polyester resin, polyamide resin, polyimide resin, polyfluoroethylene resin, etc. However, the invention should not be limited to these.

As fine particles of silicon dioxide for the inorganic substance, for example, usable are commercial products having a trade name of Aerosil R972, R972V, R974, R812, 200, 200V, 300, R202, OX50, TT600 (all by Nippon Aerosil), etc.

As fine particles of zirconium oxide for the inorganic substance, for example, usable are commercial products having a trade name of Aerosil R976 and R811 (all by Nippon Aerosil), etc.

As the organic substance, for example, preferred are polymers of silicone resin, fluororesin and acrylic resin; and more preferred is silicone resin.

Of the silicone resin, especially preferred is one having a three-dimensional network structure, for example, those having a trade name of Tospearl 103, 105, 108, 120, 145, 3120 or 240 (all by Toshiba Silicone), etc.

In the production method of the invention, the haze-having cellulose acylate film preferably contains the fine particles in an amount of from 0 to 7.5 by mass relative to the cellulose acylate. Precisely, the amount of the fine particles to be added is preferably from 0 to 7.5% by mass relative to the cellulose acylate, more preferably from 0 to 3.0% by mass, even more preferably from 0.001 to 1.0% by mass, most preferably from 0.01 to 0.5% by mass. The amount of at least 0.001% by mass is desirable from the viewpoint of improving the film transferability in production; and the amount of at most 7.5% by mass is desirable from the viewpoint of securing the toughness of the film. The toughness (absence of brittleness) of a cellulose acylate film that may be directly on-line bonded to a polarizing film, as in the present invention, is described. As compared with a film of a polymer having a flexible skeleton such as polyester or the like, the polymer skeleton of cellulose acylate is rigid, and therefore, this often provides an intrinsic problem. Accordingly, even when a plasticizer or the like is added to such a cellulose acylate film, the amount of the fine particles to be added thereto must be carefully controlled so as to fall within the above-mentioned range. In particular, in case where the cellulose acylate film is oriented and the ratio of the sound wave velocity through the film in the direction in which the sound wave velocity is the maximum to the sound wave velocity in the direction perpendicular to that direction is more than 1.05, the brittleness, if any, of the film may be more remarkably problematic, and therefore the amount of the fine particles to be added to the film must be carefully controlled.

In addition to the matter of the brittleness of the film mentioned above, another aspect of the property of the starting film for use in the production method of the invention is described. The cellulose acylate film for use in the production method of the invention gives, when processed according to the process of heat treatment and stretching to be mentioned hereinunder, a cellulose acylate film having an excellent retardation expression and having a low haze; and when the amount of the fine particles added to the film falls within the above-mentioned range, then it is favorable since the haze of the film after the process of heat treatment and stretching can be sufficiently lowered.

### (Preparation of Cellulose Acylate Solution)

The cellulose acylate solution may be prepared, for example, according to the methods described in JP-A 58-127737, 61-106628, 2-276830, 4-259511, 5-163301, 9-95544, 10-45950, 10-95854, 11-71463, 11-302388, 11-322946, 11-322947, 11-323017, 2000-53784, 2000-273184, 2000-273239. Concretely, a polymer and a solvent are mixed, stirred and swollen, and optionally cooled or heated to dissolve the polymer, and this is filtered to obtain the cellulose acylate solution.

The invention may include cooling and/or heating the mixture of polymer and solvent for the purpose of improving the solubility of the polymer in the solvent.

In case where a halogen-containing organic solvent is used as the solvent and a cellulose acylate and when the mixture of cellulose acylate and solvent is cooled, it is desirable that the mixture is cooled to −100 to 100° C. Also preferably, the method includes swelling the mixture at −10 to 39° C. prior to the cooling step, and includes heating it at 0 to 39° C. after the cooling step.

In case where a halogen-containing organic solvent is used as the solvent and the mixture of cellulose acylate and solvent is heated, it is desirable that method includes dissolving cellulose acylate in the solvent according to at least one process selected from the following (a) or (b):

(a) The mixture is swollen at −10 to 39° C., and the resulting mixture is heated at 0 to 39° C.
(b) The mixture is swollen at −10 to 39° C., then the resulting mixture is heated under 0.2 to 30 MPa and at 40 to 240° C., and the heated mixture is cooled to 0 to 39° C.

In case where a halogen-free organic solvent is used as the solvent and the mixture of cellulose acylate and solvent is cooled, the method preferably includes cooling the mixture to −100 to −10° C. Also preferably, the method includes swelling the mixture at −10 to 55° C. prior to the cooling step, and heating it at 0 to 57° C. after the cooling step.

In case where a halogen-containing organic solvent is used as the solvent and the mixture of cellulose acylate and solvent is heated, it is desirable that method includes dissolving cellulose acylate in the solvent according to at least one process selected from the following (c) or (d):

(c) The mixture is swollen at −10 to 55° C., and the resulting mixture is heated at 0 to 57° C.
(d) The mixture is swollen at −10 to 55° C., then the resulting mixture is heated under 0.2 to 30 MPa and at 40 to 240° C., and the heated mixture is cooled to 0 to 57° C.

### [Formation of Cellulose Acylate Film for Use in the Production Method of the Invention]

The cellulose acylate film for use in the production method of the invention may be produced according to a solution casting method using the above-mentioned cellulose acylate solution. The solution casting method may be attained in any ordinary manner, using an ordinary apparatus. Concretely, a dope (cellulose acylate solution) prepared in a dissolver (tank) is filtered, and then it is once stored in a storage tank in which the dope is defoamed to be a final dope. The dope is kept warmed at 30° C., and fed into a pressure die from the dope take-out port, for example, via a pressure meter gear pump via which a predetermined amount of the dope may be accurately fed to the die by controlling the revolution thereof, and then the dope is then uniformly cast onto a metal support in the casting zone that runs endlessly, through the slit of the pressure die (casting step). Next, at the peeling point at which the metal support runs almost one-round, a wet dope film (this may be referred to as a web) is peeled from the metal support, and then transported to a drying zone, in which the web is dried while transported therein by rolls. The details of the casting step and the drying step of the solution casting method are described in JP-A 2005-104148, pp. 120-146, and are suitably applicable to the invention.

The cellulose acylate film for use in the production method of the invention may also be produced according to a melt casting method, not using the above-mentioned cellulose acylate solution. The melt casting method comprises heating polymer, casting the polymer melt onto a support, and cooling it to form a film. In case where the melting point of the polymer, or the melting point of the mixture of the polymer and various additives thereto is lower than the decomposition temperature thereof and higher than the stretching temperature thereof, the melt casting method is employable. The melt casting method is described, for example, in JP-A 2000-352620.

In the invention, a metal band or a metal drum may be used as the metal support for use in formation of the un-heat-treated cellulose acylate film. In case where a cellulose acylate film produced by the use of a metal band is used and heat treatment temperature is controlled to higher than (Tc+20)° C., Rth of the heat-treated film may be low. In that case, though depending on the additives and other retardation-controlling elements, a film having Nz value 0 to 0.5 may be produced. On the other hand, in case where a cellulose acylate film produced by the use of a metal band is used and, heat treatment temperature is controlled to fall within the range of Tc to (Tc+20)° C., Rth of the heat-treated film may be high. In case where a cellulose acylate film produced by the use of a metal drum is used and heat treatment temperature is controlled to higher than (Tc+20)° C., Rth of the heat-treated film may be high. In that case, though depending on the additives and other retardation-controlling elements, a film having Nz value 0.4 or more and, as the case may be, satisfying Nz value less than 1.0 may be produced. On the other hand, in case where a cellulose acylate film produced by the use of a metal band is used and heat treatment temperature is controlled to fall within the range of Tc to (Tc+20)° C., Rth of the heat-treated film may be low. The difference in Rth after heat treatment between the cellulose acylate films for use in the production method of the invention may be because of the difference in the alignment state of the polymer chains existing in the un-heat-treated films to be caused by the difference in the external force applied to the web in the film-forming step.

### [Pre-Stretching/Wet-Stretching]

The production method of the invention preferably includes a step of pre-stretching the cellulose acylate film formed according to the above-mentioned method to thereby give the above-mentioned haze-having cellulose acylate film. Specifically, in controlling the retardation of the cellulose acylate film produced according to the production method of the invention, it is desirable that the mechanical history to be given to the cellulose acylate film before heat treatment, or that is, the external force to be given to the cellulose acylate web in the film formation process is controlled. In this, the degree of pre-stretching of the cellulose acylate film for use in the production method of the invention may be controlled through the external force control, and any of a cellulose acylate film having no haze or a haze-having cellulose acylate film can be prepared by controlling the additive and the process condition. Wet pre-stretching of cellulose acylate film may be combined with dry pre-stretching thereof for further control of the haze of the film. In case where the cellulose acylate film pre-stretched in wet does not have a haze, it is further pre-stretched at least in dry. A retardation film for use in liquid-crystal TVs is preferably such that the film traveling direction is nearly perpendicular to the in-plane slow axis direction of the film; and for this, the external force is preferably given to the film in the manner mentioned below.

That is, concretely, in case where the cellulose acylate film produced according to the production method of the invention is heat-treated at a temperature of at least (Tc+20) ° C. for having a large Re and for decreasing Rth, the cellulose acylate web is stretched preferably by from 0.1% to less than 15′, more preferably from 0.5 to 10%, even more preferably from 1 to 8%. In case where the un-heat-treated cellulose acylate film is produced while transported, it is preferably stretched in the film-traveling direction. The residual solvent amount in the cellulose acylate web to be stretched is computed according to the following equation, and is from 5 to 1000%. Preferably, the residual solvent amount is from 10 to 200%, more preferably from 30 to 150%, even more preferably from 40 to 100%.

Residual Solvent Amount (% by mass)={(M−N)/N}×100

[in the formula, M means the mass of the cellulose acylate film just before inserted into the stretching zone; and N means the mass of the cellulose acylate film just before inserted into the stretching zone, dried at 110° C. for 3 hours].

In case where the cellulose acylate film is heat-treated at least (Tc+20) ° C. for having a large Re and for increasing Rth, it is preferably the cellulose acylate web is stretched by from 15 to 300%, more preferably from 18 to 200%, even more preferably from 20 to 100%. In case where the un-heat-treated cellulose acylate film is produced while transported, it is preferably stretched in the film-traveling direction. The residual solvent amount in the cellulose acylate web to be stretched is computed according to the above equation, and is from 5 to 1000%. Preferably, the residual solvent amount is from 30 to 500%, more preferably from 50 to 300%, even more preferably from 80 to 250%

The draw ratio (elongation) of the cellulose acylate web in stretching may be attained by the peripheral speed difference between the metal support speed and the peeling speed (peeling roll draw).

On the other hand, in case where the cellulose acylate film produced according to the production method of the invention is heat-treated at Tc to (Tc+20)° C., the cellulose acylate web is stretched preferably by from 0.1 to 300%, more preferably by from 0.5 to 200%, even more preferably by from 1 to 100%. In this, when the cellulose acylate film before heat treatment is formed while it is conveyed, the film is preferably stretched in the direction perpendicular to the machine direction. The residual solvent amount in the cellulose acylate web in stretching is computed according to the above-mentioned formula, and though not specifically defined, it may be from 5 to 1000%, more preferably from 10 to 200%, even more preferably from 30 to 150%, still more preferably from 40 to 100%.

The draw ratio in stretching the cellulose acylate web may be attained by holding both sides of the cellulose acylate web with tenter clips and changing the clip-to-clip distance while the web is conveyed, thereby changing the width of the cellulose acylate web. Thus stretched, the retardation expression of the film may be controlled.

When the film having a residual solvent amount of at least 5% is stretched, then the cellulose acylate web may be stretched in relatively cold circumstance; and when the film having a residual solvent amount of at most 1000% is stretched, then the external force give to the polymer chains may be readily transmitted thereto, the cellulose acylate may be easily orientated, and the effect of the retardation expression control by stretching the solvent-containing cellulose acylate web may be thereby enhanced. The residual solvent amount in the cellulose acylate web may be suitably controlled by changing the concentration of the cellulose acylate solution, the temperature and the speed of the metal support, the temperature and the flow rate of the drying air, and the solvent gas concentration in the drying atmosphere.

In the cellulose acylate web stretching step, the web surface temperature is preferably lower from the viewpoint of transmitting the external force to the polymer. The web temperature is preferably from (Ts−100) to (Ts−0.1)° C., more preferably from (Ts−50) to (Ts−1)° C., even more preferably from (Ts−20) to (Ts−3)° C. In this, Ts means the surface temperature of the casting support. In case where the temperature of the casting support is so set that it varies in different sites, then Ts indicates the surface temperature of the support center.

Thus stretched, the cellulose acylate web is then transported into a drying zone, in which it may be clipped with a tenter at both edges, and in which it may be transported with rolls, it is dried.

The residual solvent amount in the thus-dried film is preferably from 0 to 5% by mass, more preferably from 0 to 2% by mass, even more preferably from 0 to 1% by mass, particularly preferably from 0 to 0.5% by mass. Films where the residual solvent amount is 5.0% by mass or less are preferred in the view point of effectively increasing haze of the film by the heat treatment, and the retardation expression by the heat treatment may be efficiently enhanced. After dried, the film may be treated by further haze increasing treatment or after the film is once wound up, it may be subjected to off-line such haze increasing treatment. Preferably, the cellulose acylate film before heat treatment has a width of from 0.5 to 5 m, more preferably from 0.7 to 3 m. In case where the film is once wound up, then the preferred length of the wound film is from 300 to 30000 m, more preferably from 500 to 10000 m, even more preferably from 1000 to 7000 m.

The moisture permeability of the cellulose acylate film for use in the production method of the invention is preferably at least 100 g/(m²·day) in terms of the film having a thickness of 80 μm, more preferably from 100 to 1500 g/(m²·day), even more preferably from 200 to 1000 g/(m²·day), still more preferably from 300 to 800 g/(m²·day).

In the invention, the moisture permeability may be determined as follows: A cup with calcium chloride put therein is covered with the film to be tested and airtightly sealed up therewith, and this is left at 40° C. and at a relative humidity of 90% for 24 hours. From the mass change (g/(m²·day)) before and after the conditioning, the moisture permeability of the film is determined. The moisture permeability increases with the ambient temperature elevation and with the ambient humidity increase, but not depending on the condition, the relationship of the moisture permeability between different films does not change. Accordingly, in the invention, the moisture permeability is based on the mass change at 40° C. and at a relative humidity of 90%. In addition, the moisture permeability lowers with the increase in the film thickness and increases with the reduction in the film thickness. Accordingly, the found data of the moisture permeability is multiplied by the found data of the film thickness, and then divided by 80, and the resulting value is the “moisture permeability in terms of the film having a thickness of 80 μm” in the invention.

### (Preparation of Haze-Having Film)

The production method of the invention is characterized in that a cellulose acylate film having a haze is used therein.

In that manner, the retardation expression may be enhanced and the haze per Re ((film haze)/(film Re)) may be reduced in the heat treatment step and in the subsequent re-stretching step.

“Having a haze” as referred to herein means that, after the film is conditioned at 25° C. and at a relative humidity of 60′ for 24 hours, it is analyzed with a haze meter (NDH 2000, by Nippon Denshoku Kogyo), and its haze measured is at least 0.4%, more preferably at least 0.5%. The haze-having cellulose acylate film for use in the invention preferably has a uniform haze both in the plane of the film and inside the film for producing a film having uniform optical properties. For producing such a haze-having cellulose acylate film, in addition to the pre-stretching in wet, herein employable is a method of processing the above-mentioned haze-free cellulose acylate film, or a method of forming the film with adding a particulate compound or the like. Not specifically defined but for obtaining uniform optical properties, preferred is the method of pre-stretching in wet, or the method of a treatment comprising processing a haze-free cellulose acylate film to give a haze-having cellulose acylate film. For the treatment, one preferred embodiment is a method of pre-stretching a cellulose acylate film in dry, to be mentioned bellow, produced according to a film formation method. Pre-stretching in dry means stretching to be effected prior to the heat treatment mentioned below; and after the pre-stretching (for example, during heat treatment or after heat treatment), the film may be further re-stretched. The pre-stretching in the heat treatment step or the re-stretching step afterward may enhance Re expression, may decrease the film haze per Re, or may retard any significant dimensional change in the direction perpendicular to the pre-stretching direction. Concretely, in the pre-stretching step, the film is pre-stretched within a temperature range to be mentioned below, thereby giving a haze-having cellulose acylate film.

In particular, even in the above-mentioned pre-stretching, preferred is an embodiment where a cellulose acylate film having a small original haze value is pre-stretched; and in such a case, it is desirable that a cellulose acylate film having a haze value of less than 0.4% is pre-stretched to give a cellulose acylate film having a haze value of not less than 0.4%, from the viewpoint that the haze of the film after heat treatment and stretching can be fully reduced.

When the stretching temperature is lowered, or when the draw ratio in stretching is increased, then the haze value of the cellulose acylate film may be increased. In such a case, the heat treatment temperature in the subsequent heat treatment step to be mentioned below may be set relatively low, and the ultimate range of Re and Rth of the cellulose acylate film to be finally produced herein may be increased more. The invention may comprise other step or steps between the pre-stretching step in wet or in dry and the heat treating step without overstepping the scope of the invention.

### [Pre-stretching/Dry-stretching]

In the production method of the invention, the pre-stretching temperature in dry is not limited, but is preferably effected at a temperature falling within a range of from (Tg−20) to (Tg+50)° C., in which Tg (unit, ° C.) means the glass transition temperature of the cellulose acylate film for use in the production method of the invention. When the stretching temperature is not lower than (Tg−20)° C., then it is favorable from the viewpoint of reducing the stretching unevenness and of increasing the haze value; and in that condition, the retardation expression after the heat treatment or the re-stretching may be efficiently enhanced. When the temperature is not higher than (Tg+50)° C., then it is also favorable from the viewpoint of increasing the tear strength of the film after heat treatment. The pre-stretching temperature is more preferably within a range of from (Tg−10) to (Tg+45)° C., even more preferably from Tg to (Tg+40)° C., most preferably from (Tg+5) to (Tg+35)° C. However, the pre-stretching temperature should not be higher than the heat-treatment temperature to be mentioned hereinunder. Preferably, the pre-stretching temperature is lower by at least 5° C. than the heat-treatment temperature, more preferably lower by at least 10° C., even more preferably lower by at least 15° C., still more preferably lower by at least 20° C., most preferably lower by at least 35° C.

The glass transition temperature as referred to in the invention means the boundary temperature at which the mobility of the polymer that constitutes the cellulose acylate film of the invention greatly changes. The glass transition temperature in the invention is determined as follows: 20 mg of the cellulose acylate film for use in the production method of the invention is put into the sample pan of a differential scanning calorimeter (DSC), this is heated from 30° C. up to 120° C. at a rate of 10° C./min in a nitrogen atmosphere, then kept as such for 15 minutes, then cooled to 30° C. at a rate of −20° C./min, and thereafter again heated from 30° C. up to 250° C., whereupon the temperature at which the base line begins to shift from the low-temperature side is read. This is the glass transition temperature of the film.

In the invention, the film is pre-stretched in wet and/or in dry in the manner described in the above, whereby the haze of the cellulose film is controlled, and the film of the type is preferably used in heat treatment. It may be considered that the haze may be caused by local stress concentration between the crystalline area and the amorphous area of the cellulose acylate to form fine voids in the film.

In the production method of the invention, the cellulose acylate film for use in the production method of the invention is heated up to a temperature not lower than the crystallization temperature (Tc) thereof to be mentioned below or is re-stretched, whereby it may be presumed that the structure confirmed in X-ray diffractiometry may be grown and the haze of the film may be thereby decreased and the retardation of the film may be thereby controlled. To that effect, the film is pre-stretched so that the constitutive polymer is oriented in some degree in the pre-stretching direction, and therefore, the structure confirmed in X-ray diffractiometry of the film can be efficiently and anisotropically grown even though any significant dimensional change is not given to the film in the direction perpendicular to the pre-stretching direction in the subsequent heat-treatment step. The pre-stretching temperature is lower than the heat-treatment temperature, and therefore, the cellulose acylate polymer may be oriented even though the structure confirmed in X-ray diffractiometry is not grown further, and its advantage is that the structure confirmed in X-ray diffractiometry can be efficiently grown in the subsequent heat-treatment step.

The pre-stretching direction is not specifically defined. In case where the cellulose acylate film before heat treatment is conveyed, the film may be pre-stretched in the machine direction for machine-direction stretching, or may be in the direction perpendicular to the machine direction for cross-direction stretching. In case where the in-plane slow axis of the film is to be expressed in the cross direction, in case where the heat treating temperature to be mentioned below is more than (Tc+20)° C., the machine-direction stretching is preferred. On the other hand, in case where the heat treating temperature to be mentioned below is Tc to (Tc+20)° C., the cross-direction stretching is preferred; and in case where the slow axis is to be expressed in the machine direction, in case where the heat treating temperature to be mentioned below is more than (Tc+20)° C., the cross-direction stretching is preferred. On the other hand, in case where the heat treating temperature to be mentioned below is Tc to (Tc+20)° C., the machine-direction stretching is preferred.

In the case of machine-direction stretching, the retardation expression of the film after heat treatment or re-stretching may be controlled by controlling the span length (L) relative to the film width (W) before stretching. Concretely, when the aspect ratio (L/W) is reduced, then Nz of the film after heat treatment or re-stretching may be increased; but when the aspect ratio is increased, then the Re retardation expression of the film after heat treatment or re-stretching may be enhanced. The span length as referred to herein means the length between the units of giving tension to the film in stretching, preferably the nip roll distance between at least one pair of nip rolls or suction drums, more preferably at least one pair of nip rolls.

For use for IPS-mode or VA-mode liquid crystal panels which are often used as a retardation film in a liquid crystal TV, the in-plane slow axis of the film is preferably in the cross direction.

For the method of machine-direction stretching or cross-direction stretching and for its preferred embodiments, referred to is the section of heat treatment to be given hereinunder. Preferably, the draw ratio in pre-stretching is from 0.1 to 300%, more preferably from 0.5 to 200%, even more preferably from 0.8 to 150%, still more preferably from 1 to 100%. When the draw ratio is at least 0.5%, then it is favorable from the viewpoint of increasing the haze value of the film, and the retardation expression after heat treatment may be enhanced more. When the draw ratio is at most 300%, then it is also favorable from the viewpoint of controlling the haze value to a suitable level, and its another advantage is that the film conveyance is easy. The pre-stretching may be effected in one stage or in plural stages. The “draw ratio in pre-stretching (%)” as referred to herein means one obtained according to the following formula:

Draw Ration in Pre-stretching (%)=100×{/(length after stretching)−(length before stretching)}/(length before stretching).

The drawing speed in the pre-stretching is preferably from 10 to 10000%/min, more preferably from 10 to 1000%/min, even more preferably from 10 to 800%/min. When the drawing speed is at least 10%/min, then it is favorable from the viewpoint of increasing the haze value, and the retardation expression after heat treatment may be enhanced. When the drawing speed is at most 10,000%/min, it is also favorable from the viewpoint of reducing stretching unevenness.

### [Heat Treatment]

The method for producing the cellulose acylate film of the invention is characterized by comprising heat-treating the starting cellulose acylate film at a temperature T (unit, ° C.) satisfying the condition of the following formula (I). In this, the heat treatment is preferably effected while the film is conveyed.

Tc≦T≦Tm₀ (I)

In formula (I), Tc means the crystallization temperature of the cellulose acylate film before the heat treatment, and its unit is ° C. In the invention, the crystallization temperature means the temperature at which the polymer that constitutes the cellulose acylate film forms a regular periodic structure, and at a temperature higher than the temperature, a structure to be confirmed in X-ray diffractiometry grows. The crystallization temperature in the invention is determined as follows: 20 mg of the starting cellulose acylate film before heat treatment is put into the sample pan of DSC, this is heated from 30° C. up to 120° C. at a rate of 10° C./min in a nitrogen atmosphere, then kept as such for 15 minutes, then cooled to 30° C. at a rate of −20° C./min, and thereafter again heated from 30° C. up to 300° C., and the exothermic peak starting temperature detected in the cycle is the crystallization temperature of the film. Tc generally appears on the higher temperature side than the above-mentioned glass transition temperature (Tg). For example, the crystallization temperature of a cellulose triacetate film having a total degree of substitution of 2.85 is about 190° C., though varying depending on the additive, the film-forming condition, etc. The crystallization temperature of a cellulose triacetate film having a total degree of substitution of 2.92 is about 170° C.

In formula (I), Tm₀ means the melting point of the cellulose acylate film before the heat treatment, and its unit is ° C. The melting point in the invention is determined as follows: 20 mg of the starting cellulose acylate film before heat treatment is put into the sample pan of DSC, this is heated from 30° C. up to 120° C. at a rate of 10° C./min in a nitrogen atmosphere, then kept as such for 15 minutes, then cooled to 30° C. at a rate of −20° C./min, and thereafter again heated from 30° C. up to 300° C., and the endothermic peak starting temperature detected in the cycle is the melting point of the film. Tm₀ generally appears on the higher temperature side than the above-mentioned crystallization temperature (Tc). For example, the melting point of a cellulose triacetate film having a total degree of substitution of 2.85 is about 285° C., though varying depending on the additive, the film-forming condition, etc. The melting point of a cellulose triacetate film having a total degree of substitution of 2.92 is about 290° C.

The starting cellulose acylate film is heat-treated at a temperature T satisfying the condition of formula (I), whereby the haze or the retardation expression of the cellulose acylate film may be controlled.

For example, in the preferred embodiment of the invention where the haze of the film is increased in the pre-stretching step before the heat-treatment step, it may be considered that fine voids may be formed in the film. The film is heat-treated at Tc to (Tc+20)° C., preferably at Tc to (Tc+15)° C., more preferably at Tc to (Tc+10)° C., and its haze may be reduced. This may be because the structure detectable in X-ray diffractiometry has grown and at the same time the fine voids formed around it have disappeared. It may be presumed that the heat treatment at such a temperature produces extremely small crystals, but the film does not have a remarkable negative birefringence which will be mentioned below. On the other hand, when the film is heat-treated at a higher temperature than (Tc+20)° C., more preferably at a temperature not lower than (Tc+25)° C., even more preferably at a temperature not lower than (Tc+30)° C., its haze may be reduced and especially in addition, its Re may be increased. This may be because, with the promotion of the growth of the structure therein detectable in X-ray diffractiometry, the film may begin to have a remarkable negative birefringence to be mentioned below. In this case, it may be presumed that the polymer having a relatively rigid main chain skeleton like cellulose acylate may hardly form a macrostructure like a spherical crystal, which may be often formed in a polymer having a soft main chain skeleton like polyethylene, and therefore, it is considered that the possibility of haze generation to be caused by the structure in the film detectable through X-ray diffractiometry may be low. Moreover, it is considered that the fine voids may disappear in the film, and therefore the haze of the film lowers.

Heat treatment at such a temperature T satisfying the condition of formula (I) increases Re generally by at least 15 nm than that before the heat treatment, preferably by at least 25 nm according to the aiming optical properties of a film, more preferably by at least 50 nm, even more preferably by at least 100 nm, still more preferably by at least 150 nm, furthermore preferably by at least 200 nm. The range of the Re increase may be also controlled by controlling the above-mentioned pre-stretching condition (temperature, draw ratio), the heat-treatment condition (especially temperature), etc. Heat treatment at a temperature T satisfying the condition of formula (I) makes it possible in a simplified manner to produce a cellulose acylate film having a desired retardation value that has heretofore been difficult to produce. In particular, the heat treatment also makes it possible to produce a cellulose acylate film having Nz of from −0.05 to 1.05, especially Nz of from more than 0 to less than 1, which could heretofore been produced only according to a complicated production method.

In the production method of the invention, the heat treatment is attained until the haze value of the cellulose acylate film could reach 0.3%, more preferably could be at most 0.2%. Also preferably, the heat treatment is attained until the haze reduction in the heat-treated cellulose acylate film could be at least 0.05% relative to the haze value of the cellulose acylate film before heat treatment.

In the case where stretching step is employed during the heat treating, when the cellulose acylate film is stretched especially at a temperature T satisfying Tc≦T<Tm₀−5 according to the production method of the invention, then the mobility of the cellulose acylate polymer chain may be enhanced and therefore the film may be prevented from being whitened (owing to haze increase) and from being cut or broken with the increase in the draw ratio in stretching. As described hereinunder, when the drawing speed and the draw ratio in stretching are controlled, then the balance between the aggregation and orientation of the cellulose acylate polymer chains and the thermal relaxation thereof to occur simultaneously. Accordingly, the production method of the invention enhances the aggregation and orientation of the cellulose acylate polymer chains in the film to a high degree, therefore giving a cellulose acylate film having a high modulus of elasticity, free from humidity-dependent dimensional change and having a suitable permeability.

Preferably, the heat treatment in the production method of the invention is attained while the cellulose acylate film is conveyed. The method of conveying the cellulose acylate film is not specifically defined. Typical embodiments include a method of conveying the film by nip rolls or suction drums; a method of conveying the film while held by tenter clips, and a method of flowing and conveying the film by pneumatic pressure. Preferred is the method of conveying the film by nip rolls or the method of conveying it while held by tenter clips; and more preferred is the method of conveying it while held by tenter clips. One concrete embodiment of the heat treatment comprises leading the cellulose acylate film to pass through a heat-treatment zone while held at both ends thereof with tenter clips.

Preferably, the heat treatment in the invention brings about a dimensional change of at least 10% in the direction perpendicular to the pre-stretching direction, more preferably from −10 to 10%, even more preferably from −10 to 5%, still more preferably from −5 to 3%, furthermore preferably from −3 to 1%. The film processed for heat treatment in that manner may be improved in that it is hardly cracked or broken, or is hardly waved or wrinkled like a tin plate and that the width of its product can be further broadened, while securing the retardation expression. Another advantage is that the humidity-dependent Re or Rth change of the film may be significantly reduced.

Regarding the dimensional change in the direction perpendicular to the pre-stretching direction of the film in the heat treatment, for example, when the direction of the film perpendicular to the pre-stretching direction thereof is the cross direction of the film, then the dimensional change in the cross direction owing to the heat treatment of the film may be determined as follows:

In case where the overall width of the film is shortened by the heat treatment than that of the film before the heat treatment, the dimensional change in the cross direction of the film by heat treatment is determined from the minimum overall width of the film during the heat treatment and the overall width thereof just before the heat treatment, according to the following formula:

Dimensional change in cross direction (%)=100×(minimum overall width during heat treatment−overall width just before heat treatment)/(overall width just before heat treatment).

In this, the minimum overall width during heat treatment means the width of the film that is the shortest in the cross direction thereof during the heat treatment step owing to shrinkage. For example, in case where a film having an overall width of 200 cm is shrunk to 180 cm during heat treatment, and then expanded (stretched) to 190 cm, the minimum overall width of the film during heat treatment is 180 cm.

In case where the overall width of the film is not shortened by the heat treatment than that of the film just before the heat treatment, or in case where the film is shrunk but not expanded during the heat treatment, the dimensional change in the cross direction of the film may be determined from the overall width of the film at the inlet port of the heat treatment zone and the overall width of the film at the outlet port of the heat treatment zone, according to the following formula:

Dimensional change in cross direction (%)=100×(overall width just after heat treatment−overall width just before heat treatment)/(overall width just before heat treatment).

Not adhering to any theory, the reason why the humidity dependency of retardation can be reduced by reducing the dimensional change by heat treatment at a temperature more than (Tc+20)° C. in the direction perpendicular to the pre-stretching direction of the film (preferably in the cross direction of the film) may be considered as follows: Specifically, by the heat treatment at a temperature T satisfying the condition of (Tc+20)° C. <T<Tm₀ as in the above, the crystals may be predominantly oriented and grow in the same direction as the pre-stretching direction of the film and at the same time, an oriented amorphous area may be formed around them, and the oriented amorphous area tends to form in that direction especially when some external force is applied thereto during cooling. Of those, the crystalline area has negative birefringence and the amorphous area has positive birefringence, and therefore, they act to cancel their birefringence. In the cellulose acylate film of the invention which was heat-treated at a temperature more than (Tc+20)° C., the influence of the crystalline area is large and the therefore the retardation expression may be enhanced by reducing the oriented amorphous area. On the other hand, the oriented amorphous area interacts with water molecules, and it may be considered that the environmental humidity change brings about retardation change. Accordingly, it is believed that, by reducing the oriented amorphous area in the film, the humidity dependency of retardation of the film may be thereby reduced.

For reducing the oriented amorphous area, it may be extremely effective to reduce the dimensional change in heat treatment in the direction of the film perpendicular to the pre-stretching direction thereof, and further, as so mentioned hereinunder, it will be also effective to reduce the conveyance tension in the cooling step after heat treatment and to lower the external force to be applied to the film. As a result, the humidity dependency of retardation of the film may be thereby reduced.

The film-traveling speed is generally from 1 to 500 m/min, preferably from 5 to 300 m/min, more preferably from 10 to 200 m/min, even more preferably from 20 to 100 m/min. When the film-traveling speed is at least the above-mentioned lowermost limit, 1 m/min, then the method is favorable as capable of securing a sufficient industrial producibility; and when it is at most the above-mentioned highest limit of 500 m/min, then the method is also favorable for the capability of good crystal growth promotion within a practical heat treatment zone length. When the film-traveling speed is higher, then the film coloration may be prevented more; and when it is lower, the heat treatment zone length may be shorter. Preferably, the film-traveling speed during heat treatment (the device speed of the nip rolls and the suction drum that determines the film-traveling speed) is kept constant.

The heat treatment in the production method of the invention includes, for example, a method of leading a cellulose acylate film to run in a zone having a temperature T while transported through it; a method of applying hot air to a cellulose acylate film being transported; a method of irradiating a cellulose acylate film being transported with heat rays; and a method of contacting a cellulose acylate film with a heated roll.

Preferred is the method of leading a cellulose acylate film to run in a zone having a temperature T while transported through it. One advantage of the method is that a cellulose acylate film may be heated uniformly. The temperature inside the zone may be controlled and kept constant at T by a heater while monitoring with, for example, a temperature sensor. The traveling length of the cellulose acylate film running in the zone at a temperature T may vary depending on the property of the cellulose acylate film to be produced and on the film-traveling speed; but in general, it is preferably so set that the ratio of (traveling length)/(width of the traveling cellulose acylate film) could be from 0.1 to 100, more preferably from 0.5 to 50, even more preferably from 1 to 20. In this description, the ratio may be referred to as an aspect ratio. The film-running time in the zone at a temperature T (heat treatment time) may be generally from 0.01 to 60 minutes, preferably from 0.03 to 10 minutes, more preferably from 0.05 to 5 minutes. Within the range, the retardation expressibility may be excellent and the processed film may be prevented from being colored.

In the production method of the invention, the film may be stretched at the same time of heat treatment thereof. The stretching direction in the heat treatment is not specifically defined. In case where the cellulose acylate film before heat treatment has anisotropy, preferably, the stretching is in the polymer orientation direction in the cellulose acylate film before heat treatment. The film having anisotropy as referred to herein means that the ratio of the sound wave velocity through the film in the direction in which the sound wave velocity is the maximum to the sound wave velocity in the direction perpendicular to that direction is preferably from 1.01 to 10.0, more preferably from 1.1 to 5.0, even more preferably from 1.2 to 2.5. The sound wave velocity in the direction in which the sound wave velocity is the maximum and in other various directions may be determined as follows: The film to be analyzed is conditioned at 25° C. and at a relative humidity of 60° C. for 24 hours, then using an orientation analyzer (SST-2500, by Nomura, Shoji), this is analyzed to determine the ultrasonic pulse longitudinal wave velocity through the film in the direction in which the ultrasonic pulse longitudinal wave velocity is the maximum, and in other directions.

The stretching method is not specifically defined. For example, both sides of the cellulose acylate film to be processed are held by tenter clips, and while expanded in the direction perpendicular to the machine direction (cross direction), the film is led to pass through a heating zone and is thereby stretched. When the cellulose acylate film is stretched in the direction perpendicular to the machine direction during the heat treatment, then the surface condition of the cellulose acylate film after heat treatment may be bettered. The stretching speed is preferably from 20 to 10000%/min, more preferably from 40 to 1000%/min, even more preferably from 50 to 500%/min.

During the heat treatment, the cellulose acylate film may be shrunk. Preferably, the shrinking is effected during the heat treatment. When the cellulose acylate film is shrunk during heat treatment, then its optical properties and/or mechanical properties may be controlled. The shrinking treatment may be effected not only during heat treatment but also before and after heat treatment. The shrinkage may be attained in one stage or the shrinking step and the stretching step may be effected repeatedly.

The shrinking direction of the film is not specifically defined. In case where the starting cellulose acylate film for heat treatment is produced while conveyed, preferably, the film is shrunk in the direction perpendicular to the machine direction. In case where the film is stretched (pre-stretched, etc.) before the shrinking treatment, preferably, the film is shrunk in the direction perpendicular to the stretching direction. The degree of shrinkage may be controlled by controlling the heat treatment temperature or the external force to be applied to the film. Concretely, in case where the edges of the film are held by tenter clips, the degree of shrinkage may be controlled by changing the rail-widening ratio. In case where the sides of the film are not fixed but are supported only by units of fixing the film in the machine direction thereof, the degree of shrinkage may be controlled by changing the distance between the units of fixing the film in the machine direction or by controlling the tension to be applied to the film or by controlling the quantity of heat given to the film.

The step of heat treatment of the cellulose acylate film may be once or plural times in the production method of the invention. The process of “plural times” means that after the previous heat treatment is finished, the film is once cooled to a temperature lower than Tc, then again heated up to a temperature of from Tc to lower than Tm₀, and again heat-treated while conveyed under the condition. The process of “plural times” also means that the film is heat-treated while led to pass through plural heating zones at different temperatures. In this case, the temperature may be gradually elevated in the process. In the process of heat treatment of plural times, it is desirable that the film after all the heat treatment steps satisfies the above-mentioned range of draw ratio in stretching. In the production method of the invention, preferably the heat treatment is effected at most three times, more preferably at most two times.

[Cooling after Heat Treatment]

After heat treatment, the polymer film may be cooled to a temperature lower than Tc, or may be re-stretched without cooling. In this stage, the film, especially the film which was heat-treated at a temperature more than (Tc+20)° C., is cooled while conveyed under a conveyance tension of from 0.1 to 500 N/m whereby the humidity dependency of the retardation (especially Re) of the cellulose acylate film to be finally obtained may be effectively reduced. The conveyance tension in cooling is preferably from 1 to 400 N/m, more preferably from 10 to 300 N/m, even more preferably from 50 to 200 N/m. When the conveyance tension is at least 0.1 N/m, the humidity dependency of retardation of the processed film may be reduced and the surface condition thereof may be bettered. When the conveyance tension is at most 500 N/m, then the humidity dependency of retardation of the processed film may be reduced and the absolute value of Re may be further increased.

The conveyance tension may be controlled, for example, by disposing at least a pair of tension controllers (e.g., nip rolls, suction drums) just before the cooling zone and after the cooling zone, and controlling the revolution speed of each unit. Concretely, when the ratio of the take-up speed (v2) to the feeding speed (v1) of a pair of tension controllers, (v2/v1) is reduced, then the conveyance tension is lowered; but when it is increased, then the conveyance tension is increased.

The cooling speed in cooling is not specifically defined. Preferably, the film is cooled at a speed of from 100 to 1,000,000° C./min, more preferably from 1,000 to 100,000° C./min, even more preferably from 3,000 to 50,000° C./min. The temperature range for cooling the film at such a cooling speed is preferably at least 50° C., more preferably from 100 to 300° C., even more preferably from 150 to 280° C., still more preferably from 180 to 250° C.

Controlling the cooling speed in that manner makes it possible to well control the retardation expressibility of the obtained cellulose acylate film. Concretely, when the cooling speed is made high, then the retardation expressibility may be improved. In that case, in addition, the polymer chain alignment distribution in the thickness direction of the cellulose acylate film may be reduced, and the moisture-dependent curl of the film may be prevented. The effect may be attained more favorably when the temperature range of the film cooled at a relatively rapid cooling speed is controlled to fall within the above-mentioned preferred range.

The cooling speed may be controlled by providing a cooling zone held at a temperature lower than that in the heating zone, after the heating zone and transporting the cellulose acylate film in those zones in order, or by contacting the film with a cooling roll, or by spraying cold air onto the film, or by dipping the film in a cooled liquid. The cooling speed is not required to be all the time constant during the heating step, but in the initial stage of the cooling step and in the end stage thereof, the cooling speed may be low, while between them the cooling speed may be high. The cooling speed may be determined by measuring the temperature of the film surface at different points by thermocouples disposed on the film surface, as described in Examples given hereinunder.

[Stretching after Heat Treatment (re-stretching)]

In the production method of the invention, the cellulose acylate film processed for the above-mentioned heat treatment may be stretched. (For differentiating it from other stretching, it is referred to as “re-stretching”.) Accordingly, the retardation of the transparent film to be obtained finally may be controlled more, or in case where heat treatment at a temperature more than (Tc+20)° C. was employed the humidity dependency of the retardation (especially Re) of the transparent film to be obtained finally may be effectively reduced. In particular, when the dimensional change by the heat treatment in the direction perpendicular to the pre-stretching direction of the film is at least −10%, preferably from −10 to 10%, and when the film is re-stretched under the condition, then the humidity dependency of the retardation of the film may be more effectively reduced. The re-stretching temperature may be suitably determined depending on the intended Re and Rth of the film. Preferably, the temperature is from (Tg−20)° C. to (the above-mentioned heat treatment temperature)° C., more preferably from (Tg−10)° C. to (the above-mentioned heat treatment temperature −20)° C., even more preferably from Tg to (the above-mentioned heat treatment temperature −40)° C. In this, Tg means the glass transition temperature (unit, ° C.) of the cellulose acylate film before heat treatment.

In case where the film was heat-treated at a temperature more than (Tc+20)° C., the re-stretching may reduce the oriented amorphous area, not having any significant influence on the crystalline area. Accordingly, ΔRe of the film may be reduced, while Re thereof is not too much changed. The re-stretching is preferably as follows from the viewpoint of efficiently reducing the oriented amorphous area. In case where the film is stretched in the previous heat treatment step, it is preferably re-stretched in the direction perpendicular to the stretching direction; but in case where the film is not stretched in the heat treatment step, it is preferably re-stretched in the crystal orientation direction, and in general, it is more preferably re-stretched in the cross direction (cross-direction re-stretching).

The film processed for heat treatment at Tc to (Tc+20)° C. may be re-stretched to increase the amorphous area thereof thereby increasing its Re, or as the case may be, the crystalline area that has an effect of canceling the Re generated by the amorphous area may be reduced and the Re of the film may be thereby increased. This may be because the film processed for heat treatment at such a temperature may have a small crystal size and may be mechanically weak, and therefore it may be broken by external force given thereto. The film processed for heat treatment at such a temperature is preferably re-stretched in the alignment (oriented) direction of the amorphous, and in general, it is more preferably re-stretched in the cross direction of the film.

The re-stretching may be effected after the cellulose acylate film is cooled to a temperature lower than Tc or to a temperature lower than re-stretching temperature after heat treatment, or may be effected while kept at the heat treatment temperature without being cooled.

For the re-stretching, employable is the same method as that of stretching the film during heat treatment, as described in the section of stretching during heat treatment. The re-stretching may be effected in one stage or in plural stages. Preferably, the film is re-stretched according to the method of changing the revolution speed of nip rolls to thereby stretch the film in the machine direction, or the method of holding the polymer film with tenter clips at both sides thereof and expanding it in the direction perpendicular to the machine direction (film width direction) to thereby stretch the film in that direction. More preferably, the polymer film is not stretched during heat treatment, or stretched in the machine direction by changing the revolutions peed of the nip rolls, and after the heat treatment, the film is held by tenter clips at both sides thereof and expanded in the direction perpendicular to the machine direction (film width direction) to thereby stretch the film in that direction.

The draw ratio in re-stretching may be suitably determined depending on the necessary retardation of the cellulose acylate film. Preferably, it is from 1 to 500%, more preferably from 3 to 400%, even more preferably from 5 to 300%, still more preferably from 10 to 100%. The draw ratio in re-stretching as referred to herein may be defined by the following formula:

Draw Ratio in Re-stretching (%)=100×{(length after re-stretching)−(length before re-stretching)}/(length before re-stretching).

The drawing speed in re-stretching is preferably from 10 to 10000%/min, more preferably from 20 to 1000%/min, even more preferably from 30 to 800%/min.

Re-stretching after heat treatment may control Re and Rth of the obtained transparent film more. Especially the film which was produced by the heat treatment at more than (Tc+20)° C., when the re-stretching temperature is set high, then Rth of the film may be lowered not so much changing Re thereof. When the draw ratio in re-stretching is set high, then Re of the film may be lowered and Rth thereof may be increased. These have a nearly linear correlation, and therefore, by suitably selecting the re-stretching conditions, the film may be readily processed to have the intended Re and Rth.

Before re-stretched, Re and Rth of the cellulose acylate film after the heat treatment are not specifically defined.

[Step of Contacting with Organic Solvent (Organic Solvent Contacting Step)]

In the production method for a cellulose acylate film of the invention, if desired, an organic solvent may be contacted with the surface of the cellulose acylate film and then the organic solvent may be evaporated away, whereby an adhesive layer of the cellulose acylate film may be formed. The adhesiveness enhancement is especially favorably applied to the cellulose acylate film having an increased degree of orientation. Accordingly, in case where only one surface of the cellulose acylate film is contacted with an organic solvent, and when the cellulose acylate film is directly stuck to a polarizing film, then it is desirable that the surface of the film contacted with the organic solvent is stuck to the polarizing film. The organic solvent contacting step may be attained in any stage of the production method of the invention; however, it is preferably attained after the above-mentioned pre-stretching step or heat treatment step or re-stretching step, or after the water vapor contacting step to be mentioned hereinunder, more preferably after the above-mentioned heat treatment step or re-stretching step or after the water vapor contacting step to be mentioned below. Also preferably, before or after the organic solvent contacting step, the film may be preferably processed for suitable surface treatment as in the manner mentioned below. The step of contacting the cellulose acylate film with an organic solvent (organic solvent contacting step) is described below.

### (Solvent)

The organic solvent to be used in the organic solvent contacting step preferably contains, as the main solvent thereof, a good solvent for the cellulose acylate film; and the main solvent for use in the cellulose acylate solution in the above-mentioned cellulose acylate solution casting film formation step is preferably used for it.

Not adhering to any theory, the reason why the process of contacting the cellulose acylate film with an organic solvent before the organic solvent contacting step may enhance the adhesiveness of the film to a polarizing film may be considered because the orientation of the cellulose acylate polymer in the thickness direction of the film may be disordered and the brittleness of the film in the thickness direction may be thereby retarded (interlayer delamination of the film is inhibited). On the other hand, when the orientation of the cellulose acylate polymer is disordered, then the film retardation may change, and therefore, it is desirable that the film orientation as a bulk of the film is not disordered. Accordingly, in order to satisfy both the retardation expression and the film adhesiveness to a polarizing film, the main solvent to be used in the organic solvent contacting step is preferably suitably controlled in point of the solubility of the cellulose acylate polymer therein, the volatility (driability) of the solvent and the penetrability of the solvent into the cellulose acylate film.

Specifically, of the above-mentioned good solvents, more preferred are organic solvents selected from ketones, esters and halogenohydrocarbons as the main solvent for the organic solvent for use in the organic solvent contacting step; and even more preferred are ketones and esters from the viewpoint of reducing film curling and reducing coating unevenness. The organic solvent for use in the organic solvent contacting step may suitably contain any other ingredient solid at room temperature, such as polymers, additives, etc.

Examples of preferred organic solvents and their combinations for use in, the organic solvent contacting step in the invention are mentioned below, to which, however, the invention should not be limited. The numerical values indicating the ratio are by mass.

(1) acetone=100
(2) acetone/methyl isobutyl ketone=80/20
(3) acetone/cyclohexanone=80/20
(4) acetone/cyclohexanone=60/40
(5) acetone/cyclohexanone=40/60
(6) acetone/water=95/5
(7) acetone/water=80/20
(8) acetone/methyl acetacetate/methanol/ethanol=65/20/10/5
(9) acetone/cyclopentanone/ethanol/butanol=65/20/10/5
(10) methyl ethyl ketone=100
(11) methyl ethyl ketone/cyclohexanone=80/20
(12) methyl ethyl ketone/cyclohexanone=60/40
(13) methyl ethyl ketone/cyclohexanone=40/60
(14) methyl acetate=100
(15) methyl acetate/acetone/methanol/ethanol/butanol=75/10/5/5/5
(16) methyl acetate/acetone/butanol=85/5/5
(17) methyl acetate/acetone/ethanol/butanol=80/8/8/4
(18) methyl formate/methyl ethyl ketone/acetone/methanol/ethanol=50/20/20/5/5
(19) ethyl acetate=100
(20) butyl acetate=100
(21) dichloromethane=100
(22) dichloromethane/methanol/butanol=83/15/2
(23) dichloromethane/methanol/butanol/water=85/18/1.5/0.5
(24) dichloromethane/methanol=87/13
(25) acetone/(cellulose acetate having a degree of acetyl substitution of 2.11)=99/1
(26) dichloromethane/methanol/butanol/(cellulose acetate having a degree of acetyl substitution of 2.86)=82/15/2/1

### (Contacting Step)

For contacting the cellulose acylate film with an organic solvent in the organic solvent contacting step may be any known ordinary contacting method, for which, for example, usable is any of a dipping method, an air knife coating method, a curtain coating method, a roller coating method, a wire bar coating method, a gravure coating method, a slide coating method, a spraying method, a die coating method, or an extrusion coating method of using a hopper as in U.S. Pat. No. 2,681,294. In this step, the concentration of the organic solvent to be contacted with the cellulose acylate film is preferably higher than the solvent concentration in the cellulose acylate film before contacted with the organic solvent, for effectively forming the adhesive layer.

Not specifically defined, the residual solvent amount in the cellulose acylate film before contacted with the organic solvent is preferably from 0 to 10% by mass, more preferably from 0 to 5% by mass, even more preferably from 0 to 2% by mass, from the viewpoint of the film retardation expression.

### (Drying Step)

The cellulose acylate film thus contacted with an organic solvent in the manner as above is then conveyed into a drying zone, in which it is dried while conveyed with rolls or while clipped at both sides with a tenter. In case where the organic solvent contacting step is effected prior to the above-mentioned dry stretching step or heat treatment step or re-stretching step, the subsequent step may be the drying step. The drying step may be a method of applying hot air or warm air or low-gas concentration air to the cellulose acylate film being conveyed in the zone; or a method of irradiating the film with heat rays; a method of contacting the film with a heated roll, etc. Preferred is the method of applying hot air or warm air or low-gas concentration air to the film. Not specifically defined, the temperature of the dry air is preferably from −10 to 140° C., more preferably from 25 to 120° C., even more preferably from 30 to 100° C., most preferably from 40 to 80° C. When the drying temperature is not lower than −10° C., then the film may be dried at a sufficient drying speed; and when not higher than 140° C., then the adhesiveness of the film may be effectively enhanced.

The residual solvent amount in the thus-dried cellulose acylate film is preferably not larger than the residual solvent amount of the cellulose acylate film before the organic solvent contacting treatment; and in case where the organic solvent contacting step is after the dry stretching step or the heat treatment step or the re-stretching step, the residual solvent amount in the dried film is preferably from 0 to 5% by mass, more preferably from 0 to 3% by mass, even more preferably from 0 to 2% by mass, most preferably from 0 to 1% by mass. Not specifically defined, the ratio (W₁/W₀) of the weight of the cellulose acylate film after the drying step (W₁) to the weight of the cellulose acylate film before the organic solvent contacting treatment (W₀) is preferably from 0.97 to 1.03, from the viewpoint of preventing the dried film from being curled, more preferably from 0.98 to 1.02, even more preferably from 0.99 to 1.01.

Not specifically defined, the ratio (Re₁/Re₀) of the retardation of the cellulose acylate film after the drying treatment (Re₁) to the retardation of the cellulose acylate film before the organic solvent contacting treatment (Re₀) is preferably from 0.8 to 1.2, more preferably from 0.9 to 1.1, even more preferably from 0.95 to 1.05. Within the range, the surface condition of the film is good.

Not specifically defined, the ratio (HZ₁/HZ₀) of the haze of the cellulose acylate film after the drying treatment (HZ₁) to the haze of the cellulose acylate film before the organic solvent contacting treatment (HZ₀) is preferably from 0.1 to 1.5, more preferably from 0.3 to 1.4, even more preferably from 0.5 to 1.3. Also preferably, the haze (HZ₁) of the dried cellulose acylate film is preferably at most 1.0%, more preferably at most 0.7%, even more preferably at most 0.5%. When the cellulose acylate film of the invention falling within the range is incorporated into a liquid-crystal display device, then the light leakage at the time of black level of display may be reduced and, in addition, the additives in the film can be prevented from bleeding out, and can also be prevented from bleeding out even when the film is aged, and therefore, the adhesiveness of the film to a polarizing film can be suitably controlled.

### [Water Vapor Contacting Step]

In the production method for a cellulose acylate film of the invention, if desired, a step of keeping the film contacted with a contact vapor to be mentioned below (water vapor contacting step) may be applied to the cellulose acylate film. The effect of the water vapor contacting step is not specifically defined. For example, by wet heat treatment to be taken within a short period of time, the dimensional change and the fluctuation of various physical properties (e.g., Re, Rth) of the film, which may occur in a durability test for testing the film as to whether it could keep predetermined characteristics and quality under a predetermined environmental condition, may be prevented. Not adhering to any theory, this may be considered because, when a contact vapor to be mentioned below is brought into contact with the cellulose acylate film, then the cellulose acylate film may absorb the molecules of the contact vapor and the glass transition temperature of the film is thereby lowered and, as a result, the diffusion of the molecules of the contact vapor in the cellulose acylate film is promoted as having obtained heat energy, and accordingly, the higher order structure of the cellulose acylate molecules is more readily transferred into a more stable structure therefore resulting in that, as compared with that in simple heat treatment, the structure of the cellulose acylate molecules can be stabilized within a shorter period of time. The water vapor contacting step may be attained in any stage of the production method of the invention, but is preferably attained after the above-mentioned pre-stretching step or heat treatment step or re-stretching step or organic solvent contacting step, more preferably after the above-mentioned heat treatment step or re-stretching step or organic solvent contacting step. Before or after the water vapor contacting step, the surface treatment to be mentioned hereinunder may be suitably applied to the film. The step of keeping the cellulose acylate film contacted with a water vapor-containing vapor (water vapor contacting step) is described hereinunder.

### (Contact Vapor)

Not specifically defined, the vapor to be contacted with the cellulose acylate film in the water vapor contacting step (contact vapor) may be any vapor prepared by vaporizing a solution-state solvent, but is preferably a water vapor-containing vapor, more preferably a vapor of which the main ingredient is water vapor, even more preferably water vapor itself. The vapor as the main ingredient means the vapor itself when the vapor is a single substance vapor; however, when the vapor is a mixture of plural vapors, the main ingredient of the vapor mixture means the vapor having the highest mass fraction.

The contact vapor is preferably formed in a wet vapor supply apparatus. Concretely, a solvent in the form of a solution is heated with a boiler to be a gaseous state, and then fed into a blower. The contact vapor may be suitably mixed with air. After fed into a blower, this may be heated through a heating unit. In this, the air is preferably a heated one. Thus produced, the contact vapor preferably has a temperature of from 70 to 200° C., more preferably from 80 to 160° C., most preferably from 100 to 140° C. When the temperature of the vapor is higher than the highest limit temperature, then the film may be strongly curled and is unfavorable; but when lower than the lowest limit temperature, then a sufficient effect could not be attained. In case where the contact vapor contains water, its relative humidity is preferably from 20 to 100%, more preferably from 40 to 100%, even more preferably from 60 to 100%.

The solvent in the form of a solution includes a solvent that includes water, an organic solvent or inorganic solvent. In case where water is used, it may be soft water, hard water, pure water or the like. From the viewpoint of boiler protection, preferred is soft water. Contamination of the cellulose acylate film with impurities may cause the degradation of the optical properties and the mechanical properties of the cellulose acylate film products, and therefore, it is desirable to use water with few impurities. Accordingly, for preventing the cellulose acylate film from being contaminated with impurities, use of soft water or pure water is preferred, and pure water is more preferred. Pure water has an electric resistivity of at least 1 MΩ, and in particular, the concentration of a metal ion such as sodium, potassium, magnesium, calcium or the like therein is less than 1 ppm, and the concentration of an anion such as chloride, nitrate or the like is less than 0.1 ppm. Pure water can be readily prepared through a single unit of a reverse osmosis membrane, an ion exchange resin, a distillation device or their combination. In case where an organic solvent is used, it includes methanol, acetone, methyl ethyl ketone, etc. The solvent in the form of a solution may contain a condensate liquid formed through condensation of a recovered vapor from which a contact vapor has been collected.

### (Contacting Step)

For contacting the cellulose acylate film with the above-mentioned contact vapor in the water vapor contacting step, employable is a method of applying the contact vapor to the cellulose acylate film; a method of disposing the cellulose acylate film in a space filled with the contact vapor; or a method of leading the cellulose acylate film to pass through a space filled with the contact vapor. Preferred is the method of applying the contact vapor to the cellulose acylate film, or the method of leading the cellulose acylate film to pass through a space filled with the contact vapor. Preferably, the contact between the cellulose acylate film and the contact vapor is attained while the cellulose acylate film is guided by plural rollers disposed in zigzags.

The contact time with the contact vapor is not specifically defined, but is preferably as short as possible within a range capable of exhibiting the effect of the invention, from the viewpoint of the production efficiency. The uppermost limit of the processing time is, for example, at most 60 minutes, more preferably at most 10 minutes. On the other hand, the lowermost limit of the processing time is, for example, preferably at least 10 seconds, more preferably at least 30 seconds.

Not specifically defined, the temperature of the cellulose acylate film to be contacted with the contact vapor is preferably from 100 to 150° C.

Not specifically defined, the residual solvent amount in the cellulose acylate film before contact with water vapor is preferably such that the cellulose acylate molecules has little fluidity, concretely, it is preferably from 0 to 5% by mass, more preferably from 0 to 0.3% by mass.

The contact vapor having been contacted with the cellulose acylate is fed into a condenser unit connected with a cooling unit, in which the vapor may be separated into a hot vapor and a condensed liquid.

### (Drying Step)

The cellulose acylate film thus contacted with the contact vapor in the manner as above may be cooled to almost room temperature directly as it is, or for controlling the amount of the contact vapor molecules remaining in the film, it may be conveyed into a drying zone. In case where the film is conveyed into a drying zone, preferably employed is the same drying method as that described for the drying step in the previous organic solvent contact process. In case where the water vapor contacting step is effected before the above-mentioned pre-stretching step or heat treatment step or re-stretching step or organic solvent contacting step, any of those steps may be the drying step. <<Cellulose Acylate Film>>

### (Characteristics of the Cellulose Acylate Film of the Invention)

According to the production method of the invention, a cellulose acylate film having lower haze and retardation favorably expressed therein can be obtained. In particular, a cellulose acylate film having Nz of from 0 to 1, or a cellulose acylate film having lower haze and retardation of which is largely expressed, which is difficult to produce according to conventional methods, can be produced in a relatively simplified manner. According to the production method of the invention, a cellulose acylate film having a quantity of crystallization heat of at most 2.0 J/g, a quantity of melting heat (ΔHm) of more than 0 J/g, and a micro-slow axis angle distribution of at most 3° can be easily obtained.

### (Retardation)

In this description, Re and Rth (unit, m) are determined according to the following method. First, the film to be analyzed is conditioned at 25° C. and at a relative humidity of 60% for 24 hours. Then, using a prism coupler (Model 2010 Prism Coupler, by Metricon) at 25° C. and at a relative humidity of 60%, the mean refractive index (n) of the sample, as represented by the following formula (V), is determined with a 532 nm solid laser.

n=(n_{TE}×2+n_{TM})/3 (V)

wherein n_{TE} is the refractive index measured with polarized light in the direction of the film face; n_{TM} is the refractive index measured with polarizing light in the normal direction to the film face.

In this description, Re(λ) and Rth(λ) each indicate the in-plane retardation and the thickness-direction retardation of a film at a wavelength λ (unit, nm). Re(λ) is determined, using KOBRA 21ADH or WR (by Oji Scientific Instruments), with light having a wavelength of λ nm given to a film in the normal direction thereof.

In case where the film to be analyzed is a monoaxial or biaxial index ellipsoid, then its Rth(λ) is computed as follows:

Rth(λ) is computed from the retardation that is obtained by measuring the Re(λ) at total 6 points in directions inclined every 10° from the normal direction thereof to +50° from the normal line relative to the film surface around an in-plane slow axis (determined by KOBURA 21ADH or WR) as an inclination axis (rotation axis) for an incoming light of a wavelength of λ nm entering from each of the directions of inclination, an assumed value of an average refraction index and input thickness with KOBRA 21ADH or WR.

In the above, when no specific description is given to λ and when only Re and Rth are shown, the data are with light having a wavelength of 590 nm. For the film having a tilt angle at which the retardation thereof is zero with the in-plane slow axis from the normal direction taken as the rotation axis, its retardation at a tilt angle larger than that tilt angle is converted into the corresponding negative value and then computed by KOBRA 21ADH or WR.

With the slow axis taken as the tilt axis (rotation axis) (in case where the film does not have a slow axis, any desired in-plane direction of the film may be taken as the rotation axis), a retardation is determined in any desired two tilt directions, and based on the found data and the mean refractive index and the inputted film thickness, Rth of the film may also be computed according to the following formulae (VI) and (VII):

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} \qquad ( VI )$$

wherein Re(θ) means a retardation in the direction tilted by an angle θ from the normal direction; nx means the refractive index in the in-plane slow axis direction; ny means the refractive index in the direction perpendicular to the in-plane nx; nz means the refractive index in the direction perpendicular to nx and ny; d means the thickness of the film.

Rth=((nx+ny)/2−nz)×d. (VII)

In case where the film to be analyzed could not be expressed as a monoaxial or biaxial index ellipsoid, or in case where the film to be analyzed has no optical axis, then its Rth(λ) may be computed as follows:

Rth(λ) is computed from the retardation that is obtained by measuring the Re (λ) at total eleven points in directions inclined every 10° from −50° up to +50° from the normal line relative to the is film surface around an in-plane slow axis (determined by KOBURA 21ADH or WR) as an inclination axis (rotation axis) for an incoming light of a wavelength of λ nm entering from each of the directions of inclination, an assumed value of an average refraction index and input thickness with KOBRA 21ADH or WR.

By inputting the value of these average refraction indices and thickness, KOBRA 21ADH or WR computes nx, ny, nz. From the computed nx, ny, nz, Nz=(nx−nz)/(nx−ny) is computed further.

According to the production method of the invention, a cellulose acylate film having Re of at least 40 nm can be obtained with ease. It is desirable that the value of Re is suitably controlled in accordance with the type of the intended liquid-crystal display device. In case where the intended panel is an IPS-mode panel, Re of the cellulose acylate film of the invention is preferably from 60 to 400 nm, more preferably from 80 to 300 nm. In case where the intended panel is a VA-mode panel, Re of the cellulose acylate film of the invention is preferably from 40 to 200 nm, more preferably from 45 to 100 nm, even more preferably from 50 to 80 nm, and Rth thereof is preferably from 80 to 300 nm, more preferably from 100 to 200 nm, even more preferably from 110 to 150 nm.

### (Crystallization Temperature)

The cellulose acylate film processed for heat treatment at a higher temperature than (Tc+20)° C. according to the production method of the invention does not show a crystallization temperature. In general, the cellulose acylate film before heat treatment shows a crystallization temperature, but the cellulose acylate film processed for heat treatment at a higher temperature than (Tc+20)° C. according to the production method of the invention does not show a crystallization temperature.

On the other hand, of the cellulose acylate films produced according to the production method of the invention, those processed for heat treatment at a temperature of from Tc to (Tc+20)° C. shows a crystallization temperature.

Preferably, the cellulose acylate film produced according to the production method of the invention is suitably controlled according to the type of the intended liquid-crystal display device. In case where the intended panel is an IPS-mode panel, Nz represented by the above formula (IV) of the film is preferably from 0 to 1, more preferably from 0.1 to 0.9, even more preferably from 0.2 to 0.8, still more preferably from 0.3 to 0.7. In case where the intended panel is a VA-mode panel, Nz of the cellulose acylate film of the invention is preferably from more than 1 to 20, more preferably from 1.5 to 10, even more preferably from 2 to 7.

The Nz value of the cellulose acylate film processed for the above-mentioned heat treatment may be suitably increased by applying the above-mentioned stretching (re-stretching) step after the heat treatment thereto.

### (Humidity Dependency)

In the invention, the humidity dependency of Re (ΔRe) and the humidity dependency of Rth (ΔRth) are computed from the in-plane and thickness-direction retardation at a relative humidity H (unit, %), Re (H %) and Rth(H %), according to the following formulae:

ΔRe=Re(10%)−Re(80%)

ΔRth=Rth(10%)−Rth(80%)

Re(H %) and Rth(H %) are as follows: The film to be analyzed is conditioned at 25° C. and a relative humidity H % for 24 hours, then at 25° C. and relative humidity H %, the retardation of the film at a relative humidity H % and a wavelength 590 nm is determined according to the above-mentioned method; and from the data, Re(H %) and Rth(H %) are computed. Mere expression Re alone, not accompanied by a value of relative humidity, means the data measured at a relative humidity 60%.

The retardation values of the cellulose acylate film of the invention, as measured under different humidity conditions, preferably satisfy the following relational formulae:

|ΔRe/Re|<0.5, and

|ΔRth|<50.

More preferably, they satisfy the following relational formulae:

|ΔRe/Re|<0.3, and

ΔRth|<40.

Even more preferably, they satisfy the following relational formulae:

|ΔRe/Re|<0.2, and

|ΔRth|<30.

Also preferably, the retardation value of the cellulose acylate film of the invention, as measured under different humidity conditions, preferably satisfies the following relational formula:

|ΔRe|<50.

More preferably, it satisfies the following relational formula:

|ΔRe|<40.

Even more preferably, it satisfies the following relational formula:

|ΔRe|<30.

Most preferably, it satisfies the following relational formula:

|ΔRe|<20.

Controlling the retardation values under different humidity conditions makes it possible to reduce the retardation change in varying external environments, thereby providing liquid crystal display devices of high reliability.

### (Slow Axis)

Preferably, in the cellulose acylate film of the invention, the angle, θ, between the machine direction in the production of the film and the slow axis of Re of the film is 0±10° or 90±10°, more preferably 0±5° or 90±5°, even more preferably 0±3° or 90±30, as the case may be, still more preferably 0±1° or 90±1°, most preferably 90±1°.

### (Micro-Slow Axis Angle Distribution)

The cellulose acylate film of the invention has a quantity of crystallization heat of at most 2.0 J/g and a quantity of melting heat (ΔHm) of more than 0 J/g, and has a micro-slow axis angle distribution of at most 3°.

In the invention, the micro-slow axis angle distribution of the film is as follows: The film is conditioned at 25° C. and a relative humidity of 60′ for 24 hours, and then the in-plane slow axis angle is measured at intervals of 1 mm in an area of 50 mm square, and the found data are processed to give a standard deviation. For the measurement, usable is a birefringence meter (ABR-10A, by Uniopto) equipped with a scannable sample stage; or a polarization/retardation analysis/measurement system (AxoScan, by AXOMETRICS) equipped with an XY stage; or a device having a constitution of He—Ne laser/rotatable ¼ wavelength plate/beam expander/sample holder/focusing lens/rotatable polarizing element/CCD camera in that order. In case where the device equipped with an XY stage is used, the beam diameter of the light to be used must be small, approximately from 1 to 2 mm. When the beam diameter is large, 3 mm or more, then the device gives the data of slow axis angle as the mean value of the area to which the beam is applied, and in such a case, the micro-slow axis angle distribution could not be determined.

It has been found that a film having a quantity of crystallization heat of at most 2.0 J/g and having a quantity of melting heat (ΔHm) of more than 0 J/g, like the cellulose acylate film of the invention, has a problem of contract reduction in the liquid-crystal display device comprising the film, which may be caused by the micro-slow axis angle distribution of the film. Accordingly, the micro-slow axis angle distribution of the film of the invention is at most 3°, preferably at most 1.5°, more preferably at most 1°, even more preferably at most 0.5°, most preferably at most 0.2°. Such a small micro-slow axis angle distribution of the film may be further reduced by controlling the orientation condition of the film before heat treatment and, as the case may be, by controlling the orientation condition of the film after heat treatment, according to the production method of the invention.

### (Quantity of Crystallization Heat)

The quantity of crystallization heat of the cellulose acylate film of the invention is at most 2.0 J/g, preferably from 0 to 1.5 J/g, more preferably from 0 to 1.0 J/g, even more preferably from 0 to 0.5 J/g. The quantity of crystallization heat is as follows: 20 mg of the film is put into a sample pan for DSC, this is heated from 30° C. up to 120° C. at a rate of 10° C./min in a nitrogen stream atmosphere, then kept as such for 15 minutes, and thereafter cooled down to 30° C. at a rate of −20° C./min, and further, this is again heated from 30° C. up to 300° C., and the area surrounded by the exothermic peak appearing in the heat cycle and the base line of the sample is measured. This is the quantity of crystallization heat of the tested film.

### (Quantity of Melting Heat)

The cellulose acylate film of the invention has a quantity of melting heat (ΔHm) of more than 0 J/g, preferably from 5 to 45 J/g, more preferably from 10 to 40 J/g, even more preferably from 15 to 35 J/g. The quantity of melting heat is as follows: From 5 to 6 mg of the film is put into a sample pan for DSC, this is heated from 30° C. up to 120° C. at a rate of 20° C./min in a nitrogen stream atmosphere, then kept as such for 15 minutes, and thereafter cooled down to 30° C. at a rate of −20° C./min, and further, this is again heated from 30° C. up to 300° C., and the area surrounded by the endothermic peak appearing in the heat cycle and the base line of the sample is measured. This is the quantity of melting heat of the tested film.

The cellulose acylate film of the invention shows its melting temperature as the top of the endothermic peak. Specifically, the quantity of melting heat of the film is more than 0 J/g.

A cellulose acylate film not showing the above-mentioned crystallization temperature and the quantity of melting heat naturally could not form a regular structure, and therefore it could not express a desired retardation and does not satisfy the object of the invention, Specifically, the cellulose acylate film before heat treatment may have both a crystallization temperature and a melting temperature, but the cellulose acylate film after heat treatment may have or may not have a crystallization temperature but has a melting temperature.

Preferably, as the film for use in the production method of the invention, preferred is the film naturally having Tm₀.

### (Haze Before Heat Treatment)

In the invention, the cellulose acylate film before heat treatment has a haze. Concretely, when the film is conditioned at 25° C. and a relative humidity of 60% for 24 hours, and then analyzed with a haze meter (NDH 2000, by Nippon Denshoku Kogyo), its haze is at least 0.4%, preferably from 1.0%; to less than 30%, more preferably from 1.5% to less than 25%, even more preferably from 1.5 to 20%, still more preferably from 1.5 to 10%, most preferably from 1.5 to 6.0%. The haze value of the cellulose acylate film that is to be the starting material for the haze-having cellulose acylate film is less than 0.5%, preferably at most 0.4%, more preferably at most 0.3%.

Preferably, the haze value of the cellulose acylate film before heat treatment is increased by pre-stretching, and concretely, the haze value thereof may be controlled to a predetermined level according to the above-mentioned pre-stretching method. The degree of the increase in the haze value may depend on various conditions such as the type of the materials constituting the cellulose acylate film (for example, the type of the cellulose acylate and the type of the additive), the method of dissolving the dope for use in film formation, the method of film formation, etc. When the haze value is at least 0.4%, the retardation expression of the film after heat treatment or after re-stretching may be efficiently enhanced. In particular, when the haze value is from 0.5% to less than 30%, then the toughness of the film in its production may be further enhanced and the film conveyance may be easier. The cellulose acylate film containing fine particles in an amount of from 0 to 7.5% by mass and having a haze value of at least 1.5% is a novel film, and the cellulose acylate film having a haze value of from 1.5% to less than 25% is also a novel film, and these are useful in that they can efficiently express retardation when heat-treated or re-stretched. These films are described hereinunder.

Not adhering to any theory, by controlling a haze value of the cellulose acylate film to at least 0.4% before heat treatment, the retardation expression of a cellulose acylate film after heat treatment or re-stretching is enhanced and this may be because of the following reasons: Specifically, when a cellulose acylate film having a haze of less than 0.4% is pre-stretched, then the polymer chain orientation in the film may be promoted; however, when the haze of the film is not as yet increased, the polymer chain orientation could not go on sufficiently. On the other hand, for example, the step of suitably controlling the pre-stretching condition to increase the haze value would be a step of stretching the film while forming microvoids in the film, and the polymer chain orientation could be promoted to a high degree. On the other hand, in the heat treatment step where the haze value is decreased and the retardation expression is enhanced by promoting the polymer chain crystallization, it is desirable that the polymer chain orientation degree is previously appropriately controlled for attaining more efficient and anisotropic crystallization, and owing to the presence of microvoids, the polymer chain mobility may be fully secured in the heat treatment step, and therefore, the orientation may be promoted more efficiently and the retardation expression of the film after heat treatment or re-stretching may be enhanced efficiently. Accordingly, by increasing the haze value of the cellulose acylate film before heat treatment, the retardation expression of the film after heat treatment or re-stretching may be enhanced.

(Haze after Heat Treatment)

In the invention, when the cellulose acylate film after heat treatment is used in optical applications of, for example, retardation films, supports of retardation films, protective films for polarizers and liquid crystal display devices, it is preferably transparent, and its haze is preferably smaller. Preferably, the haze of the film is at most 1.0%, more preferably at most 0.7%, even more preferably at most 0.5%, most preferably at most 0.3%. In case where a haze-having cellulose acylate film produced according to a method of pre-stretching an already-produced cellulose acylate film is used, the mobility of the molecules in the film may be fully enhanced in the above-mentioned heat treatment step, thereby bringing about rearrangement of the polymer chains and the microvoids in the film and promoting recrystallization; and accordingly, by controlling the treatment temperature in the heat treatment step in the manner mentioned hereinabove, the processed film may have a haze of at most 1.0%.

In the production method of the invention, the difference (HZ₁−HZ₀) between the haze (HZ₀) of the cellulose acylate film before the heat treatment step and the haze (HZ₁) of the cellulose acylate film after the heat treatment step is preferably at least 0.05% from the viewpoint of reducing more the haze of the film after the heat treatment, more preferably from 0.1 to 30%, even more preferably from 0.5 to 10%.

Further, the production method of the invention may further include a stretching (re-stretching) step after the heat treatment step of the film; and the re-stretched film is preferably transparent and has a smaller haze value in case where it is used in optical applications such as liquid-crystal display devices. Preferably, the haze value of the re-stretched film is at most 1.0%, more preferably at most 0.7%, even more preferably at most 0.5%, most preferably at most 0.3%.

### (Haze Per Re)

Another characteristic feature of the cellulose acylate film of the invention produced according to the production method of the invention is that its haze per Re ((haze value of the film)/(Re value of the film)) is small. The haze per Re of the cellulose acylate film of the invention is, for example, preferably from 0.001 to 0.05.

### (Film Thickness)

Preferably, the thickness of the cellulose acylate film of the invention is from 20 μm to 180 μm, more preferably from 30 μm to 160 μm, even more preferably from 40 μm to 120 μm. When the film thickness is at least 20 μm, then the film is favorable in point of the handlability thereof in working the film into polarizer or the like and of the ability thereof to prevent curling of polarizer. Also preferably, the thickness unevenness of the cellulose acylate film of the invention is from 0 to 2% both in the film-traveling direction and in the cross direction, more preferably from 0 to 1.5%, even more preferably from 0 to 1%.

### (Moisture Permeability)

The moisture permeability of the cellulose acylate film of the invention is preferably at least 100 g/(m²·day) in terms of the film having a thickness of 80 μm. Having the moisture permeability of at least 100 g/(m²·day) in terms of the film having a thickness of 80 μm, the film may be readily stuck to a polarizing film. The moisture permeability in terms of the film having a thickness of 80 μm is more preferably from 100 to 1500 g/(m²·day), even more preferably from 200 to 1000 g/(m²·day), still more preferably from 300 to 800 g/(m²·day).

In case where the cellulose acylate film of the invention is used as an outer protective film that is not disposed between a polarizing film and a liquid-crystal cell as in the embodiment described below, the moisture permeability of the cellulose acylate film of the invention is preferably less than 500 g/(m²·day) in terms of the film having a thickness of 80 μm, more preferably from 100 to 450 g/(m²·day), even more preferably from 100 to 400 g/(m²·day), most preferably from 150 to 300 g/(m²·day). Within the range, the durability of polarizer to moisture or to wet heat may be improved, and liquid-crystal display devices of high reliability can be provided.

### (Sound Wave Velocity (Sound Speed))

In the invention, the direction in which the sound wave velocity is the maximum through the film is determined as follows: The film to be analyzed is conditioned at 25° C. and a relative humidity of 60% for 24 hours, then using an orientation analyzer (SST-2500, by Nomura Shoji), this is analyzed to determine the direction thereof in which the ultrasonic pulse longitudinal wave velocity is the maximum.

### (Constitution of Cellulose Acylate Film)

The cellulose acylate film of the invention may have a single-layered structure or a multi-layered structure, but preferably has a single-layered structure. The “single-layered” film as referred to herein means a one-sheet type polymer film, not a laminate film of plural films stuck together. This includes a one-sheet type polymer film produced by a successive casting process or a co-casting process from plural cellulose acylate solutions. In this case, by suitably controlling the type and the amount of additives, the molecular distribution of the polymer and the type of the polymer, a polymer film having a distribution in the thickness direction may be produced. One-sheet film may have various functional parts such as an optically-anisotropic part, an antiglare part, a gas-barrier part, a moisture-resistant part, etc.

### (Surface Treatment)

The cellulose acylate film of the invention may be suitably surface-treated so as to improve its adhesion to various functional layers (e.g., undercoat layer, back layer, optically-anisotropic layer). The surface treatment includes glow discharge treatment, UV irradiation treatment, corona treatment, flame treatment, saponification treatment (acid saponification, alkali saponification); and glow discharge treatment and alkali saponification treatment are preferred. The “glow discharge treatment” is a treatment of processing a film surface with plasma in the presence of a plasma-exciting vapor. The details of the surface treatment are described in Hatsumei Kyokai Disclosure Bulletin (No. 2001-1745, published by the Hatsumei. Kyokai on Mar. 15, 2001), and may be suitably applied to the invention.

For improving the adhesiveness between the film surface and a functional layer thereon, an undercoat layer (adhesive layer) may be provided on the cellulose acylate film of the invention, in addition to the surface treatment or in place of the surface treatment thereof. The undercoat layer is described in Hatsumei Kyokai Disclosure Bulletin (No. 2001-1745, published by the Hatsumei Kyokai on Mar. 15, 2001), p. 32, which may be suitably applied to the invention. The functional layers that may be provided on a cellulose acylate film are described in Hatsumei Kyokai Disclosure Bulletin (No. 2001-1745, published by the Hatsumei Kyokai on Mar. 15, 2001), pp. 32-45, and they may be suitably applied to the cellulose acylate film the invention.

### <<Cellulose Acylate Film for Use in the Production Method of the Invention>>

The cellulose acylate film of the invention, which is used in the production method of the invention, is characterized, in that it contains fine particles in an amount of from 0 to 7.5% by mass added thereto and has a haze value of at least 1.5%. The film of the type is useful in that it may efficiently express retardation when heat-treated or re-stretched.

The cellulose acylate film of the invention, which is used in the production method of the invention, preferably has a haze value of from 1.5% to less than 25% from the viewpoint of more efficiently enhancing the retardation expression of the cellulose acylate film of the invention that is produced according to the production method of the invention, and more preferably, has a haze value of from 1.5% to 10%.

The preferred type of the fine particles is the same as the preferred range of the type of the fine particles for use in the production method of the invention; and the preferred amount of the fine particles to be added is also the same as the preferred range of the amount of the fine particles to be added in the production method of the invention.

The cellulose acylate film of the invention that is used in the production method of the invention is preferably such that the ratio of the sound wave velocity through the film in the direction in which the sound wave velocity is the maximum to the sound wave velocity in the direction perpendicular to that direction is from 1.05 to 10.0, from the viewpoint of controlling the brittleness of the cellulose acylate film containing fine particles added thereto, more preferably from 1.1 to 5.0, even more preferably from 1.2 to 2.5.

In case where the cellulose acylate film of the invention that is used in the production method of the invention contains fine particles in an amount of from 0 to 7.5% by mass added thereto and has a haze value of from 1.5% to less than 25%, it may be suitably used as a light diffusive film directly as it is, and, for example, it may be incorporated into an image display device as a light diffusive film. In addition, it may also be incorporated in a polarizer as a light diffusive protective film for polarizer.

Heat-treating or re-stretching the cellulose acylate film of the invention that is used in the production method of the invention further enhances the retardation expression of the cellulose acylate film of the invention obtained according to the production method of the invention.

The cellulose acylate film of the invention that is used in the production method of the invention preferably has a haze uniformly in the face of the film and inside the film for producing a film having uniform optical properties.

### (Production Method for Cellulose Acylate Film for Use in the Production Method of the Invention)

The cellulose acylate film of the invention that is used in the production method of the invention can be produced according to a method satisfying a specific condition of the above-mentioned methods for preparing “haze-having cellulose acylate film”.

Specifically, a cellulose acylate film containing fine particles in an amount of from 0 to 7.5% by mass added thereto may be preferably pre-stretched at (Tg−20)° C. to (Tg+50)° C. with the draw ratio of at least 40% or at (Tg−10) ° C. to (Tg+10)° C. with a draw ratio of at least 30%, more preferably pre-stretched at (Tg−10) ° C. to (Tg+30)° C. with a draw ratio of at least 50% or at (Tg−5) ° C. to (Tg+5)° C. with a draw ratio of at least 30%, thereby giving the cellulose acylate film containing fine particles in an amount of from 0 to 7.5% by mass added thereto and having a haze value of at least 1.5%.

### <<Retardation Film>>

The retardation film of the invention is characterized by having at least one cellulose acylate film of the invention. The cellulose acylate film of the invention may be used as a retardation film. “Retardation film” is meant to indicate an optical material having optical anisotropy which is used generally in display devices such as liquid-crystal display devices, and it has the same meaning as that of retardation plate, optical compensatory sheet, optical compensatory film, etc. In a liquid-crystal display device, the retardation film is used for the purpose of increasing the display panel contrast and of improving the viewing angle characteristics and the color of the device.

Using the cellulose acylate t film of the invention facilitates the production of a retardation film having desired Re and Rth.

A plurality of the cellulose acylate films of the invention may be laminated, or the cellulose acylate film of the invention may be laminated with any other film not falling within the scope of the invention, thereby controlling Re and Rth of the resulting laminate, and the laminate may be used as a retardation film. The film lamination may be attained by the use of a sticky paste or an adhesive.

As the case may be, the cellulose acylate film of the invention may be used as a support of a retardation film, and an optically-anisotropic layer of liquid crystal or the like may be provided on it to construct a retardation film of the invention. The optically-anisotropic layer to be applied to the retardation film of the invention may be formed of, for example, a liquid-crystalline compound-containing composition or a birefringent polymer film, or may be formed of the cellulose acylate film of the invention.

In case where the above-mentioned organic solvent contacting step is carried out as the post-step after the step of forming the optically-anisotropic layer, it is desirable that the organic solvent is contacted with the other surface of the film opposite to the surface thereof on which the optically-anisotropic layer is formed.

The liquid-crystalline compound is preferably a discotic liquid-crystalline compound or a rod-shaped liquid-crystalline compound.

### [Discotic Liquid-Crystalline Compound]

Examples of discotic liquid-crystalline compounds usable in the invention are described in various documents (e.g., C. Destrade et al., Mol. Cryst. Liq. Cryst., Vol. 71, p. 111 (1981); Quarterly Journal of General Chemistry, edited by the Chemical Society of Japan, No. 22, Chemistry of Liquid Crystal, Chap. 5, Chap. 10, Sec. 2 (1994); B. Kohne et al., Angew. Chem. Soc. Chem. Comm., p. 1794 (1985): J. Zhang et al., J. Am. Chem. Soc., Vol. 116, p. 2655 (1994)).

In the optically-anisotropic layer, the discotic liquid-crystalline molecules are preferably fixed as aligned. Most preferably, the molecules are fixed through polymerization. Polymerization of discotic liquid-crystalline molecules is described in JP-A 8-27284. For fixing the discotic liquid-crystalline molecules through polymerization, the discotic core of the discotic liquid-crystalline molecules must be substituted with a polymerizing group. However, when a polymerizing group is bonded directly to the discotic core, then the molecules could hardly keep their alignment state during polymerization. Accordingly, a linking group is introduced between the discotic core and the polymerizing group. Polymerizing group-having discotic liquid-crystalline molecules are described in JP-A 2001-4387.

### [Rod-Shaped Liquid-Crystalline Compound]

Examples of rod-shaped liquid-crystalline compounds usable in the invention are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolanes and alkenylcyclohexylbenzonitriles. The rod-shaped liquid-crystalline compound for use herein is not limited to these low-molecular liquid-crystalline compounds but includes polymer liquid-crystalline compounds.

In the optically-anisotropic layer, the rod-shaped liquid-crystalline molecules are preferably fixed as aligned. Most preferably, the molecules are fixed through polymerization. Examples of the polymerizing rod-shaped liquid-crystalline compound usable in the invention are described, for example, in Makromol. Chem., Vol. 190, p. 2255 (1989); Advanced Materials, Vol. 5, p. 107 (1993); U.S. Pat. Nos. 4,683,327, 5,622,648, 5,770,107, WO95/22586, WO95/24455, WO97/00600, WO98/23580, WO98/52905, JP-A 1-272551, 6-16616, 7-110469, 11-80081, 2001-328973.

### <Polarizer>>

The polarizer of the invention is characterized by having at least one cellulose acylate film of the invention. The cellulose acylate film and the retardation film of the invention may be used as a protective film for polarizer (polarizer of the invention). The polarizer of the invention comprises a polarizing film and two polarizer-protective films that protect both surfaces of the polarizing film, in which the cellulose acylate film or the retardation film of the invention is used as at least one polarizer-protective film.

In case where the cellulose acylate film of the invention is used as the above-mentioned, polarizer-protective film, it is desirable that the cellulose acylate film of the invention is subjected to the above-mentioned surface treatment (as in JP-A 6-94915, 6-118232) for hydrophilicating its surface. For example, the film is preferably processed by glow discharge treatment, corona discharge treatment or alkali saponification. In particular, when the polymer that constituted the cellulose acylate film of the invention is cellulose acylate, then alkali saponification is the most preferred for the surface treatment.

The polarizing film for use herein may be prepared by dipping a polyvinyl alcohol film in an iodine solution and stretching it. In case where such a polarizing film prepared by dipping a polyvinyl alcohol film in an iodine solution and stretching it is used, the cellulose acylate film of the invention may be directly stuck to both surfaces of the polarizing film with an adhesive, with its surface-treated face being inside of the resulting structure. In the production method of the invention, it is desirable that the cellulose acylate film is directly stuck to a polarizing film in that manner. The adhesive may be an aqueous solution of polyvinyl alcohol or polyvinyl acetal (e.g., polyvinyl butyral), or a latex of a vinylic polymer (e.g., polybutyl acrylate). An aqueous solution of a completely-saponified polyvinyl alcohol is especially preferred for the adhesive.

In a liquid-crystal display device, in general, a liquid-crystal cell is provided between two polarizers. The device therefore has four polarizer-protective films. The cellulose acylate film of the invention may be applied to any of those four polarizer-protective films, but preferably it is used especially advantageously as the protective film to be disposed between the polarizing film and the liquid-crystal layer (liquid-crystal cell) in the liquid-crystal display device. The protective film to be disposed on the opposite side to the cellulose acylate film of the invention with a polarizing film sandwiched therebetween may be provided with a transparent hard coat layer, an antiglare layer, an antireflection layer or the like. In particular, the cellulose acylate film of the invention is favorably used as a polarizer-protective film of the outermost surface on the display side of liquid-crystal display device.

### <<Liquid-Crystal Display Device>>

The cellulose acylate film, the retardation film and the polarizer of the invention may be used in liquid-crystal display devices of various display modes. The liquid-crystal display devise of the invention is characterized by having at least one cellulose acylate film of the invention or by having at least one polarizer of the invention. Various liquid-crystal modes in which the film is used are described below. Of those modes, the cellulose acylate film, the retardation film and the polarizer of the invention are especially favorably used in VA-mode and IPS-mode liquid-crystal display devices. The liquid-crystal display devices may be any of transmission-type, reflection-type or semitransmission-type ones.

In one preferred embodiment of the liquid-crystal display device of the invention, the in-plane retardation (Re, unit: nm) is at least 40 nm, and the display mode is a VA mode. Also preferably, Nz represented by the following formula (IV) is from more than 1 to 20, and the display mode is a VA mode. Also preferably, the in-plane retardation (Re, unit: nm) is at least 40 nm, Nz represented by the following formula (IV) is from more than 1 to 20, and the display mode is a VA mode.

Nz=(nx−nz)/(nx−ny) (IV)

wherein nx means the refractive index of the film in the in-plane slow axis (x) direction thereof;
ny means the refractive index of the film in the direction perpendicular to the in-plane x direction thereof;
nz means the refractive index of the film in the thickness-direction (in the in-plane normal direction) thereof; the slow axis is in the direction in which the in-plane refractive index of the film is the largest.

In another preferred embodiment of the liquid-crystal display device of the invention, the in-plane retardation (Re, unit: nm) is at least 40 nm, and the display mode is an IPS mode. Also preferably, Nz represented by the above formula (IV) is from 0 to 1, and the display mode is an IPS mode. Also preferably, the in-plane retardation (Re, unit: nm) is at least 40 nm, Nz represented by the above formula (IV) is from 0 to 1, and the display mode is an IPS mode.

### (TN-Mode Liquid-Crystal Display Device)

The cellulose acylate film of the invention may be used as a support of the retardation film in a TN-mode liquid-crystal display device having a TN-mode liquid-crystal cell. TN-mode liquid-crystal cells and TN-mode liquid-crystal display devices are well known from the past. The retardation film for use in TN-mode liquid-crystal display devices is described in JP-A3-9325, 6-148429, 8-50206, 9-26572; and in Mori et al's reports (Jpn. J. Appl. Phys., Vol. 36 (1997), p. 143; Jpn. J. Appl. Phys., Vol. 36 (1997), p. 1068).

### (STN-Mode Liquid-Crystal Display Device)

The cellulose acylate film of the invention may be used as a support of the retardation film in an STN-mode liquid-crystal display device having an STN-mode liquid-crystal cell. In an STN-mode liquid-crystal display device, in general, the rod-shaped liquid-crystalline molecules in the liquid-crystal cell are twisted within a range of from 90 to 360 degrees, and the product (And) of the refractivity anisotropy (Δn) of the rod-shaped liquid-crystalline molecules and the cell gap (d) falls within a range of from 300 to 1500 nm. Retardation films for use in STN-mode liquid-crystal display devices are described in JP-A 2000-105316.

### (VA-Mode Liquid-Crystal Display Device)

The cellulose acylate film of the invention may be used as the retardation film or as a support of the retardation film in a VA-mode liquid-crystal display device having a VA-mode liquid-crystal cell. The VA-mode liquid-crystal display device may be a domain-division system device, for example, as in JP-A 10-123576. The polarizer with the cellulose acylate film of the invention in these embodiments contributes toward viewing angel expansion and contract improvement.

### (IPS-Mode Liquid-Crystal Display Device and ECB-Mode Liquid-Crystal Display Device)

The cellulose acylate film of the invention is especially advantageously used as the retardation film, as a support of the retardation film or as a protective film of the polarizer in an IPS-mode liquid-crystal display device and an ECB-mode liquid-crystal display device having an IPS-mode or ECB-mode liquid-crystal cell. In these modes, the liquid-crystal material is aligned nearly in parallel to each other at the time of black level of display, and under a condition of no voltage application thereto, the liquid-crystalline molecules are aligned in parallel to the substrate face to give black display. In these embodiments, the polarizer with the cellulose acylate film of the invention contributes toward viewing angel expansion and contract improvement.

### (OCB-Mode Liquid-Crystal Display Device and HAN-Mode Liquid-Crystal Display Device)

The cellulose acylate film of the invention is advantageously used as a support of the retardation film in an OCB-mode liquid-crystal cell-having OCB-mode liquid-crystal display device or a HAN-mode liquid-crystal cell-having HAN-mode liquid-crystal display device. It is desirable that, in the retardation film in an OCB-mode liquid-crystal display device and a HAN-mode liquid-crystal display device, the direction in which the absolute value of the retardation of the film is the smallest is neither the in-plane direction nor the normal direction of the retardation film. The optical properties of the retardation film for use in an OCB-mode liquid-crystal display device or a HAN-mode liquid-crystal display device depend on the optical properties of the optically-anisotropic layer, the optical properties of the support and the configuration of the optically-anisotropic layer and the support of the film. Retardation films for use in an OCB-mode liquid-crystal display device and a HAN-mode liquid-crystal display device are described in JP-A 9-197397. In addition, they are also described in Mori et al's report (Jpn. J. Appl. Phys., Vol. 38 (1999), p. 2834).

### (Reflection-Type Liquid-Crystal Display Device)

The cellulose acylate film of the invention may be advantageously used as the retardation film of TN-mode, STN-mode, HAN-mode or GH (guest-host)-mode reflection-type liquid-crystal display devices. These display modes are well known from the past. TN-mode reflection-type liquid-crystal display devices are described in JP-A 10-123478, WO98/48320, Japanese Patent 3022477. Retardation films for use in reflection-type liquid-crystal display devices are described in WO00/65384.

### (Other Liquid-Crystal Display Devices)

The cellulose acylate film of the invention may be advantageously used as a support of the retardation film in an ASM (axially symmetric aligned microcell)-mode liquid-crystal cell-having ASM-mode liquid-crystal display device. The ASM-mode liquid-crystal cell is characterized in that the cell thickness is held by a position-controllable resin spacer. The other properties of the cell are the same as those of the TN-mode liquid-crystal cell. ASM-mode liquid-crystal cells and ASM-mode liquid-crystal display devices are described in Kume et al's report (Kume et al., SID 98 Digest 1089 (1998)).

### (Hard Coat Film, Antiglare Film, Antireflection Film)

As the case may be, the cellulose acylate film of the invention may be applied to a hard coat film, an antiglare film and an antireflection film. For the purpose of improving the visibility of LCD, PDP, CRT, EL and the like flat panel displays, any or all of a hard coat layer, an antiglare layer and an antireflection layer may be given to one face or both faces of the cellulose acylate film of the invention. Preferred embodiments of such antiglare films and antireflection films are described in detail in Hatsumei Kyokai Disclosure Bulletin (No. 2001-1745, published by the Hatsumei Kyokai on Mar. 15, 2001), pp. 54-57, and these are also preferred for the cellulose acylate film of the invention.

### EXAMPLES

The invention is described in more detail with reference to the following Examples. In Examples, the material used, its amount and the ratio, the details of the treatment and the treatment process may be suitably modified or changed not overstepping the scope of the invention. Accordingly, the invention, should not be limitatively interpreted by the Examples mentioned below. Unless otherwise specifically indicated, part and % in Examples are all by mass.

### <<Measurement Methods>>

Measurement methods and evaluation methods for the properties used are described below.

### [Glass Transition Temperature (Tg)]

20 mg of an un-heat-treated cellulose acylate film is put into a sample pan for DSC, heated in a nitrogen atmosphere at a rate of 10° C./min from 30° C. up to 120° C., kept as such for 15 minutes, and then cooled to 30° C. at a rate of −20° C./min. Then, this is again heated from 30° C. up to 250° C., and the temperature at which the base line of the temperature profile of the sample begins to deviate from the low-temperature side is referred to as glass transition temperature of the film.

### [Melting Temperature (Tm₀)]

20 mg of an un-heat-treated cellulose acylate film is put into a sample pan for DSC, heated in a nitrogen atmosphere at a rate of 10° C./min from 30° C. up to 120° C., kept as such for 15 minutes, and then cooled to 30° C. at a rate of −20° C./min. Then, this is again heated from 30° C. up to 300° C., and the endothermic peak starting temperature detected in the test is melting temperature of the film.

### [Quantity of Crystallization Heat]

The film is analyzed according to the method mentioned in the above thereby to determine the quantity of crystallization heat of the film.

### [Quantity of Melting Heat]

The film is analyzed according to the method mentioned in the above thereby to determine the quantity of melting heat of the film.

### [Micro-Slow Axis Angle Distribution]

A birefringence meter (AER-10A, by Uniopto) equipped with a scannable sample stage and a 0.75 mmφ He—Ne laser, the film is analyzed to determine the slow axis data thereof. From the found data, the standard deviation is computed to be the micro-slow axis angle distribution of the film.

### [Crystallization Temperature (Tc)]

20 mg of an un-heat-treated cellulose acylate film is put into a sample pan for DSC, heated in a nitrogen atmosphere at a rate of 10° C./min from 30° C. up to 120° C., kept as such for 15 minutes, and then cooled to 30° C. at a rate of −20° C./min. Then, this is again heated from 30° C. up to 300° C., and the exothermic peak starting temperature detected in the test is crystallization temperature of the film.

### [Residual Solvent Amount]

From the mass M of the cellulose acylate film and the mass N of the cellulose acylate film dried at 110° C. for 3 hours, the residual solvent amount is computed according to the following formula:

Residual Solvent Amount (mas.%)={(M−N)/N}×100.

### [Degree of Substitution]

The degree of acyl substitution of the cellulose acylate film is determined by ¹³C-NMR according to the method described in Carbohydr. Res., 273 (1995), 83-91 (Tezuka, et al).

### [Retardation]

The film to be analyzed is sampled at five points in the cross direction thereof (center, and both edges (at the position of 5% of the overall width from both edges), and two intermediates between the center and the edge) at intervals of 100 m in the machine direction, thereby giving samples having a size of 5 cm×5 cm. These samples are tested according to the method mentioned above. The retardation data of every point are averaged to give Re and Rth, and the in-plane slow axis direction is thereby determined.

### [Haze]

The film is sampled in the same manner as that in determination of retardation. The samples are conditioned at 25° C. and relative humidity of 60% for 24 hours, and analyzed with a haze meter (NDH 2000, by Nippon Denshoku Kogyo). The data are averaged to give the haze of the sample.

After pre-stretched, after heat-treated, and after re-stretched, the film in every stage is partly sampled, and then cooled directly as it is, and this is conditioned and analyzed according to the method mentioned in the above.

### [Degree of Polarization]

Two polarizers produced are put one upon another to determine the transmittance (Tp) with their absorption axes kept parallel to each other, and the transmittance (Tc′) with their absorption axes kept perpendicular to each other. The degree of polarization (P) is computed according to the following formula:

Degree of Polarization P=((Tp−Tc′)/(Tp+Tc′))^{0.5}

### <<1>> Production and Evaluation of Cellulose Acylate Film

### (Preparation of Polymer Solution)

### 1) Cellulose Acylate:

Of the following cellulose acylates A to E, those described, in Table 1 were selected and used. Each cellulose acylate was heated and dried at 120° C. to have a water content of at most 0.5% by mass. 20 parts by mass of the polymer was used.

### Cellulose Acylate A:

A powder of cellulose acetate having a degree of substitution of 2.94 was used. The viscosity-average degree of polymerization of the cellulose acylate A was 300, and the degree of 6-position acetyl substitution thereof was 0.94.

### Cellulose Acylate B:

A powder of cellulose acetate propionate having a degree of acetyl substitution of 2.28 and a degree of propionyl substitution of 0.70 was used. The viscosity-average degree of polymerization of the cellulose acylate B was 280.

### Cellulose Acylate C:

A powder of cellulose acetate having a degree of substitution of 2.86 was used. The viscosity-average degree of polymerization of the cellulose acylate C was 300, the degree of 6-position acetyl substitution thereof was 0.89, the acetone extract was 7% by mass, the ratio of mass-average molecular weight/number-average molecular weight was 2.3, the water content was 0.2% by mass, the viscosity in 6% by mass dichloromethane solution was 305 mPa·s, the residual acetic acid amount was at most 0.1% by mass, the Ca content was 65 ppm, the Mg content was 26 ppm, the iron content was 0.8 ppm, the sulfate ion content was 18 ppm, the yellow index was 1.9, and the free acetic acid amount was 47 ppm. The mean grain size of the powder was 1.5 mm, and the standard deviation was 0.5 mm.

### Cellulose Acylate D:

A powder of cellulose acetate having a degree of substitution of 2.70 was used. The viscosity-average degree of polymerization of the cellulose acylate D was 250, and the degree of 6-position acetyl substitution thereof was 0.84.

### Cellulose Acylate E:

A powder of cellulose acetate having a degree of substitution of 2.81 was used. The viscosity-average degree of polymerization of the cellulose acylate E was 305, and the degree of 6-position acetyl substitution thereof was 0.89.

### 2) Solvent:

Of the following solvent A or solvent B, those described in Table 1 were selected and used. The water content of each solvent was at most 0.2% by mass.

### Solvent A:

Dichloromethane/methanol/butanol=83/15/2 by mass.

### Solvent B:

Dichloromethane/methanol=87/13 by mass.

### 3) Additives:

Of the following additives A to G, those described in Table 1 were selected and used.

### Additive A:

Silicon dioxide particles (particle size, 20 nm; Mohs hardness, about 7) (0.08 parts by mass).

### Additive C:

Triphenyl phosphate (1.6 parts by mass),

Biphenyldiphenyl phosphate (0.8 parts by mass),

Silicon dioxide particles (particle size, 20 nm; Mohs hardness, about 7) (0.08 parts by mass).

### Additive E:

PP-29 mentioned above (2.4 parts by mass)

Silicon dioxide particles (particle size, 20 nm; Mohs hardness, about 7) (0.08 parts by mass).

### Additive F:

Triphenyl phosphate (1.6 parts by mass),

Biphenyldiphenyl phosphate (0.8 parts by mass),

Compound Al mentioned above (1.5 parts by mass).

### Additive G:

Triphenyl phosphate (1.6 parts by mass),

Biphenyldiphenyl phosphate (0.8 parts by mass),

Compound Al mentioned above (1.1 parts by mass).

### 4) Dissolution:

In Examples and Comparative Examples, the ingredients were swollen and dissolved according to the process shown in Table 1, as selected from the following dissolution step A or B.

### Dissolution Process A:

The above-mentioned solvent and additive were put into a 400-liter stainless dissolver tank having a stirring blade and surrounded by cooling water running around it, and with stirring and dispersing them, the above-mentioned cellulose acylate was gradually added thereto. After the addition, this was stirred at room temperature for 2 hours, then swollen for 3 hours, and then again stirred to give a cellulose acylate solution.

For the stirring, used were a dissolver-type eccentric stirring shaft running at a peripheral speed of 15 m/sec (shear stress 5×10⁴ kgf/m/sec² [4.9×10⁵ N/m/sec²]), and a stirring shaft having an anchor blade at the center thereof and running at a peripheral speed of 1 m/sec (shear stress 1×10⁴ kgf/m/sec² [9,8×10⁴ N/m/sec²]). The swelling was attained by stopping the high-speed stirring shaft, and the anchor blade-having stirring shaft was driven at a peripheral speed of 0.5 m/sec.

The swollen solution was heated up to 50° C. by transferring it to a jacket-covered line, and, was further heated up to 90° C. under pressure of 2 MPa, whereby it was completely dissolved. The heating time was 15 minutes. In this process, the filter, the housing, and the pipe exposed to high temperatures were all made of corrosion-resistant Hastelloy alloy, and these were covered with a jacket for heat carrier circulation therethrough for heating the system.

Next, this was cooled to 36° C. to give a cellulose acylate solution.

### Dissolution Process B:

The above-mentioned solvent and additive were put into a 400-liter stainless dissolver tank having a stirring blade and surrounded by cooling water running around it, and with stirring and dispersing them, the above-mentioned cellulose acylate was gradually added thereto. After the addition, this was stirred at room temperature for 2 hours, then swollen for 3 hours, and then again stirred to give a cellulose acylate mixture.

For the stirring, used were a dissolver-type eccentric stirring shaft running at a peripheral speed of 15 m/sec (shear stress 5×10⁴ kgf/m/sec² [4.9×10⁵ N/m/sec²]), and a stirring shaft having an anchor blade at the center thereof and running at a peripheral speed of 1 m/sec (shear stress 1×10⁴ kgf/m/sec² [9.8×10⁴ N/m/sec²]). The swelling was attained by stopping the high-speed stirring shaft, and the anchor blade-having stirring shaft was driven at a peripheral speed of 0.5 m/sec.

The swollen mixture was transferred from the tank via a screw pump heated at 30° C. at the center part thereof, while cooling it from the outer peripheral part of the screw so that the mixture could pass through the cooling area at −70° C. for 3 minutes. The cooling was attained by the coolant cooled at −75° C. by a refrigerator. The mixture thus obtained by cooling was heated up to 30° C. while transferred via a screw pump, and then put into a stainless chamber.

Next, this was stirred at 30° C. for 2 hours to give a cellulose acylate solution.

### 5) Filtration:

The obtained cellulose acylate solution was filtered through a paper filter having an absolute filtration accuracy of 10 μm (#63, by Toyo Filter Paper), and then through a metal sintered filter having an absolute filtration accuracy of 2.5 μm (FH025, by Pall), thereby giving a polymer solution.

### (Formation, of Film)

Of the following film formation process A or B, one as indicated in Table 1 was selected and used.

### Film Formation Process A:

The above-mentioned cellulose acylate solution was heated at 30° C., and then cast onto a mirror-face stainless support having a band length of 60 m set at 15° C. through a caster, Giesser (described in JP-A 11-314233). The casting speed was 50 m/min, the coating width was 200 cm. The space temperature in the entire casting zone was set at 15° C. At 50 cm before the end point of the casting zone, the cellulose acylate film thus cast and rolled was peeled off from the band, and exposed to dry air at 45° C. applied thereto. In Table 1, the sample processed in the pre-stretching step B was held with tenter clips at both sides of the peeled web, and stretched in the cross direction under the condition shown in Table 1. Next, this was further dried at 110° C. for 5 minutes and at 140° C. for 10 minutes, thereby giving a transparent cellulose acylate film.

### Film Formation Process B:

The above-mentioned polymer solution was heated at 30° C., and then cast onto a mirror-face stainless support, drum having a diameter of 3 m, through a caster, Giesser. The surface temperature of the support was set at −5° C., the casting speed was 100 m/min, and the coating width was 200 cm. The space temperature in the entire casting zone was set at 15° C. At 50 cm before the end point of the casting zone, the cellulose acylate film thus cast and rolled was peeled off from the drum, and then both edges of the film were clipped with a pin tenter. The cellulose acylate film thus held by the pin tenter was conveyed into a drying zone. In the initial stage of drying, the film was exposed to dry air at 45° C. applied thereto. Next, this was further dried at 110° C. for 5 minutes and at 140° C. for 10 minutes, thereby giving a transparent cellulose acylate film.

The haze, the residual solvent amount, Tg, Tc and Tm₀ of the produced transparent films were determined. The results are shown in Table 1. The haze of the transparent film produced herein is shown as “haze (a)” in Table 1.

### (Pre-Stretching)

Of the pre-stretching process A or pre-stretching process B, those described in Table 1 were selected and used.

The draw ratio in pre-stretching of the film was determined as follows: Reference lines are given to the film at regular intervals in the direction perpendicular to the machine direction, and the distance between them is measured before and after heat treatment, and the draw ratio is computed according to the following formula:

Draw Ratio in Pre-stretching of Film (%)=100×(reference line distance after pre-stretching−reference line distance before pre-stretching)/(reference line distance before pre-stretching).

In every Example, the film width reduction after pre-stretching was from 10 to 25%.

The haze of each film after pre-stretching was measured, and the results are shown in Table 1 as “haze (b)”. In Comparative Examples 101, 102 and 105, the films were not pre-stretched.

### Pre-stretching Process A:

The cellulose acylate film produced in the above was monoaxially stretched in the machine direction, using a roll stretcher. The roll of the roll stretcher was an induction heater jacket roll having a mirror-polished surface; and the temperature of every roll was made controllable separately. The stretching zone was covered with a casing and kept at the temperature shown in Table 1. The former roll in the stretching zone was so designed that the film could be gradually heated up to the temperature shown in Table 1. The draw ratio was controlled by controlling the peripheral speed of the nip rolls. The aspect ratio (distance between nip rolls/base inlet port width) and the drawing speed are shown in Table 1.

### Pre-Stretching Step B:

Both sides of the cellulose acylate web peeled from the band in the above-mentioned film forming step were held with tenter clips, and the film was stretched in the cross direction. The stretching zone was covered with a casing kept at the temperature shown in Table 1, and the draw ratio in stretching was controlled to have the value shown in Table 1 by changing the width between the tenter rails.

The following heat treatment step A or B was selected and shown in Table 1. For confirming the fluctuation in the haze value of the film before and after the heat treatment step, the film after the heat treatment step was partly sampled and then cooled directly as it was, not processed in the re-stretching step. The data of the haze value (b′) of the films after the heat treatment step are shown in Table 1. The difference between the haze (b) of the film after the pre-stretching step and the haze (b′) thereof after the heat treatment step is also shown in Table 1.

### Heat Treatment Process A:

Both sides of the obtained film were held with tenter clips, and the film was led to pass through a heating zone. The dimensional change in the cross direction was controlled by controlling the expansion ratio of the tenter. The temperature in the heating zone and the dimensional change in the cross direction determined according to the above-mentioned method are shown in Table 1.

### Heat Treatment Process B:

The obtained film was heat-treated, using a device having a heating zone between two nip rolls. The aspect ratio (distance between nip rolls/base width) was controlled to be 3.3; the base temperature before the heating zone was 25° C.; and the temperature in the heating zone is as in Table 1. The speed ratio (v₁₁/v₁₀) of the take-up nip roll speed (v₁₁) to the feeding nip roll speed (v₁₀) was 1.20. The dimensional change in the cross direction determined according to the above-mentioned method is shown in Table 1.

### (Re-Stretching)

Both sides of the obtained film were held with tenter clips, and the film was stretched in the direction perpendicular to the machine direction in a heating zone. The temperature in the heating zone and the draw ratio in re-stretching, as computed from the tenter expansion ratio, are shown in Table 1. In the heat treatment process A, the film was held with the tenter clips before the inlet port of the heat treatment zone, and directly as such, this was led to run into the re-stretching zone not removing the tenter clips from it.

### (Evaluation of Cellulose Acylate Film Produced)

The obtained cellulose acylate film was rolled up as a roll of 3900 m film.

The haze, Re and Rth of the each cellulose acylate film thus produced were measured, and Nz was computed from the found data. The results are shown in Table 1 below. The haze of the cellulose acylate film obtained in this stage is “haze (c)” in Table 1.

TABLE 1

| | | | | | | Dis- | Film | | | | | | | | | | |
|---|---|---|---|---|---|---|---|---|---|---|---|---|---|---|---|---|---|
| | Cellulose | | | | | solu- | For- | | Resid- | | | | Pre-Stretching | | | | |
| | Ac- | | | | | tion | mation | Haze | ual | | | | | Temper- | Draw | | |
| | yl- | SA + | | Addi- | Sol- | Pro- | Pro- | (a) | Solvent | Tg | Tc | Tm0 | Pro- | ature | Ratio | Speed | Aspect |
| | ate | SB | SB | tive | vent | cess | cess | [%] | [%] | [° C.] | [° C.] | [° C.] | cess | [° C.] | [%] | [%/min] | Ratio |
| Example 101 | A | 2.94 | 0.00 | A | A | A | A | 0.3 | 0.1 | 150 | 160 | 290 | A | 155 | 30 | 50 | 1 |
| Example 102 | A | 2.94 | 0.00 | A | A | A | A | 0.3 | 0.1 | 150 | 160 | 290 | A | 180 | 40 | 50 | 1 |
| Example 103 | A | 2.94 | 0.00 | A | A | A | A | 0.3 | 0.1 | 150 | 160 | 290 | A | 130 | 30 | 50 | 1 |
| Example 104 | A | 2.94 | 0.00 | A | A | A | A | 0.3 | 0.1 | 150 | 160 | 290 | A | 150 | 30 | 50 | 1 |
| Example 105 | A | 2.94 | 0.00 | A | A | A | A | 0.3 | 0.1 | 150 | 160 | 290 | A | 150 | 40 | 50 | 1 |
| Example 106 | A | 2.94 | 0.00 | A | A | A | A | 0.3 | 0.1 | 150 | 160 | 290 | A | 150 | 50 | 50 | 1 |
| Example 107 | A | 2.94 | 0.00 | A | A | A | A | 0.3 | 0.1 | 150 | 160 | 290 | A | 150 | 60 | 50 | 1 |
| Comparative | A | 2.94 | 0.00 | A | A | A | A | 0.3 | 0.1 | 150 | 160 | 290 | — | — | — | — | — |
| Example 101 | | | | | | | | | | | | | | | | | |
| Comparative | A | 2.94 | 0.00 | A | A | A | A | 0.3 | 0.1 | 150 | 160 | 290 | — | — | — | — | — |
| Example 102 | | | | | | | | | | | | | | | | | |
| Example 108 | A | 2.94 | 0.00 | A | A | A | A | 0.3 | 0.1 | 150 | 160 | 290 | A | 150 | 40 | 50 | 1 |
| Example 109 | A | 2.94 | 0.00 | A | A | A | A | 0.3 | 0.1 | 150 | 160 | 290 | A | 150 | 40 | 50 | 3 |
| Example 110 | A | 2.94 | 0.00 | A | A | A | A | 0.3 | 0.1 | 150 | 160 | 290 | A | 150 | 40 | 50 | 1 |
| Comparative | A | 2.94 | 0.00 | A | A | A | A | 0.3 | 0.1 | 150 | 160 | 290 | A | 150 | 40 | 50 | 1 |
| Example 103 | | | | | | | | | | | | | | | | | |
| Comparative | A | 2.94 | 0.00 | A | A | A | A | 0.3 | 0.1 | 150 | 160 | 290 | A | 150 | 40 | 50 | 1 |
| Example 104 | | | | | | | | | | | | | | | | | |
| Example 111 | A | 2.94 | 0.00 | A | A | A | A | 0.3 | 0.1 | 150 | 160 | 290 | A | 150 | 40 | 50 | 1 |
| Example 112 | A | 2.94 | 0.00 | A | A | A | A | 0.3 | 1.5 | 145 | 155 | 290 | A | 150 | 40 | 50 | 1 |
| Example 113 | A | 2.94 | 0.00 | A | A | A | A | 0.3 | 0.1 | 150 | 160 | 290 | A | 150 | 40 | 50 | 0.5 |
| Example 114 | A | 2.94 | 0.00 | A | A | A | A | 0.3 | 0.1 | 150 | 160 | 290 | A | 150 | 40 | 50 | 3 |
| Comparative | A | 2.94 | 0.00 | A | A | A | A | 0.3 | 0.1 | 150 | 160 | 290 | — | — | — | — | — |
| Example 105 | | | | | | | | | | | | | | | | | |
| Example 115 | A | 2.94 | 0.00 | A | A | A | A | 0.3 | 0.1 | 150 | 160 | 290 | A | 150 | 40 | 10 | 1 |
| Example 116 | A | 2.94 | 0.00 | A | A | A | A | 0.3 | 0.1 | 150 | 160 | 290 | A | 150 | 40 | 100 | 1 |
| Example 117 | A | 2.94 | 0.00 | A | A | A | A | 0.3 | 0.1 | 150 | 160 | 290 | A | 150 | 40 | 1000 | 1 |
| Example 118 | B | 2.98 | 0.70 | A | A | A | A | 0.3 | 0.1 | 145 | 155 | 280 | A | 150 | 40 | 50 | 1 |
| Example 119 | B | 2.98 | 0.70 | C | A | A | A | 0.3 | 0.1 | 140 | 150 | 280 | A | 150 | 40 | 50 | 1 |
| Example 120 | B | 2.98 | 0.70 | A | A | A | A | 0.3 | 0.1 | 145 | 155 | 280 | A | 150 | 40 | 50 | 1 |
| Example 121 | C | 2.86 | 0.00 | A | A | A | A | 0.3 | 0.1 | 155 | 200 | 285 | A | 150 | 40 | 50 | 1 |
| Example 122 | D | 2.7 | 0.00 | A | A | A | A | 0.3 | 0.1 | 145 | 240 | 280 | A | 150 | 30 | 50 | 1 |
| Example 123 | E | 2.81 | 0.00 | F | B | A | A | 0.4 | 45 | 140 | 200 | 280 | B | 150 | 30 | 50 | — |
| Example 124 | E | 2.81 | 0.00 | F | B | A | A | 0.4 | 45 | 140 | 200 | 280 | B | 150 | 30 | 50 | — |
| Example 125 | E | 2.81 | 0.00 | F | B | A | A | 0.4 | 45 | 140 | 200 | 280 | B | 150 | 10 | 50 | — |
| Comparative | E | 2.81 | 0.00 | F | B | A | A | 0.3 | 45 | 140 | 200 | 280 | B | 150 | 1 | 50 | — |
| Example 106 | | | | | | | | | | | | | | | | | |
| Example 126 | E | 2.81 | 0.00 | G | B | A | A | 0.3 | 45 | 140 | 200 | 280 | B | 150 | 1 | 50 | — |
| Example 127 | A | 2.94 | 0.00 | C | A | A | A | 0.3 | 0.1 | 145 | 155 | 290 | A | 150 | 40 | 50 | 1 |
| Example 128 | A | 2.94 | 0.00 | E | A | A | A | 0.3 | 0.1 | 145 | 155 | 290 | A | 150 | 40 | 50 | 1 |
| Example 129 | A | 2.94 | 0.00 | A | A | B | A | 0.3 | 0.2 | 150 | 160 | 290 | A | 150 | 40 | 50 | 1 |
| Example 130 | A | 2.94 | 0.00 | A | A | A | B | 0.2 | 0.1 | 145 | 155 | 285 | A | 15O | 40 | 50 | 1 |

| | | Heat Treatment | | | | | | | | | | | |
|---|---|---|---|---|---|---|---|---|---|---|---|---|---|
| | | | | Dimen- | Re-stretching | | | | | | | | |
| | Haze | | Temper- | sional | Temper- | Draw | Haze | Haze (b)- | Haze | | Retardation | | |
| | (b) | Pro- | ature | Change | ature | Ratio | (b′) | Haze (b′) | (c) | | Re | Rth | |
| | [%] | cess | [° C.] | [%] | [° C.] | [%] | (%] | [%] | [%] | [°] | [nm] | [nm] | Nz |
| Example 101 | 0.5 | A | 240 | 0 | 240 | 2 | 0.3 | 0.2 | 0.3 | 0.5 | 151 | 20 | 0.63 |
| Example 102 | 0.8 | A | 240 | 0 | 240 | 2 | 0.3 | 0.5 | 0.3 | 0.3 | 169 | 16 | 0.59 |
| Example 103 | 1.0 | A | 240 | 0 | 240 | 2 | 0.3 | 0.7 | 0.3 | 0.8 | 154 | 37 | 0.74 |
| Example 104 | 2.1 | A | 240 | 0 | 240 | 2 | 0.3 | 1.8 | 0.3 | 0.5 | 149 | 25 | 0.67 |
| Example 105 | 3.4 | A | 240 | 0 | 240 | 2 | 0.3 | 3.1 | 0.3 | 0.3 | 161 | 29 | 0.68 |
| Example 106 | 8.2 | A | 240 | 0 | 240 | 2 | 0.3 | 7.9 | 0.3 | 0.2 | 175 | 32 | 0.68 |
| Example 107 | 23 | A | 240 | 0 | 240 | 2 | 0.3 | 22.7 | 0.3 | 0.1 | 193 | 36 | 0.69 |
| Comparative | 0.3 | A | 240 | 0 | 240 | 2 | 0.3 | 0.0 | 0.3 | 3.5 | 2 | 1 | 1 |
| Example 101 | | | | | | | | | | | | | |
| Comparative | 0.3 | — | — | — | — | — | 0.3 | 0.0 | 0.3 | 3.3 | 1 | −35 | −34.5 |
| Example 102 | | | | | | | | | | | | | |
| Example 108 | 3.4 | A | 180 | 0 | 180 | 2 | 0.3 | 3.1 | 0.3 | 0.2 | 106 | 13 | 0.62 |
| Example 109 | 3.4 | A | 180 | 0 | 180 | 2 | 0.3 | 3.1 | 0.3 | 0.2 | 112 | 6 | 0.55 |
| Example 110 | 3.4 | A | 260 | 0 | 260 | 2 | 0.3 | 3.1 | 0.3 | 0.5 | 224 | 34 | 0.65 |
| Comparative | 3.4 | A | 155 | 0 | — | — | 3.4 | 0.0 | 3.4 | 0.2 | 28 | 4 | 0.64 |
| Example 103 | | | | | | | | | | | | | |
| Comparative | 3.4 | A | 295 | 0 | — | — | — | — | — | — | — | — | — |
| Example 104 | | | | | | | | | | | | | |
| Example 111 | 3.4 | A | 240 | −8 | 240 | 2 | 0.3 | 3.1 | 0.3 | 0.3 | 170 | 29 | 0.67 |
| Example 112 | 2.7 | A | 240 | 0 | 240 | 2 | 0.3 | 2.4 | 0.3 | 0.3 | 167 | 18 | 0.61 |
| Example 113 | 3.4 | B | 260 | −50 | — | — | 0.3 | 3.1 | 0.3 | 0.4 | 263 | −60 | 0.27 |
| Example 114 | 3.4 | B | 260 | −50 | — | — | 0.3 | 3.1 | 0.3 | 0.4 | 298 | −143 | 0.02 |
| Comparative | 0.3 | A | 260 | −50 | — | — | 0.3 | 0.0 | 0.3 | 4.1 | 0 | −107 | 0.01 |
| Example 105 | | | | | | | | | | | | | |
| Example 115 | 3.4 | A | 240 | 0 | 240 | 2 | 0.3 | 3.1 | 0.3 | 0.2 | 158 | 31 | 0.7 |
| Example 116 | 3.4 | A | 240 | 0 | 240 | 2 | 0.3 | 3.1 | 0.3 | 0.3 | 162 | 26 | 0.66 |
| Example 117 | 3.4 | A | 240 | 0 | 240 | 2 | 0.3 | 3.1 | 0.3 | 0.3 | 168 | 17 | 0.6 |
| Example 118 | 2.8 | A | 240 | 0 | 240 | 2 | 0.3 | 2.5 | 0.3 | 0.3 | 272 | −64 | 0.26 |
| Example 119 | 3.0 | A | 240 | 0 | 240 | 2 | 0.3 | 2.7 | 0.3 | 0.3 | 282 | 0 | 0.5 |
| Example 120 | 2.8 | A | 260 | 0 | 260 | 2 | 0.3 | 2.5 | 0.3 | 0.6 | 342 | −85 | 0.25 |
| Example 121 | 3.0 | A | 240 | 0 | 240 | 2 | 0.3 | 2.7 | 0.3 | 0.3 | 131 | 6 | 0.55 |
| Example 122 | 1.8 | A | 260 | 0 | 260 | 2 | 0.3 | 1.5 | 0.3 | 0.5 | 60 | 1 | 0.52 |
| Example 123 | 0.8 | A | 200 | 0 | 160 | 20 | 0.2 | 0.6 | 0.2 | 0.4 | 55 | 120 | 2.68 |
| Example 124 | 0.8 | A | 220 | 0 | 160 | 20 | 0.1 | 0.7 | 0.1 | 0.3 | 45 | 120 | 3.17 |
| Example 125 | 0.6 | A | 200 | 0 | 160 | 40 | 0.2 | 0.4 | 0.3 | 0.2 | 60 | 120 | 2.50 |
| Comparative | 0.4 | A | 160 | 0 | 160 | 50 | 0.4 | 0.0 | 2.0 | 0.2 | 55 | 125 | 2.78 |
| Example 106 | | | | | | | | | | | | | |
| Example 126 | 0.4 | A | 200 | 0 | 160 | 50 | 0.3 | 0.1 | 0.5 | 0.1 | 55 | 110 | 2.50 |
| Example 127 | 4.3 | A | 240 | 0 | 240 | 2 | 0.3 | 4 | 0.3 | 0.3 | 199 | 55 | 0.78 |
| Example 128 | 3.1 | A | 240 | 0 | 240 | 2 | 0.3 | 2.8 | 0.3 | 0.3 | 188 | 36 | 0.69 |
| Example 129 | 3.4 | A | 240 | 0 | 240 | 2 | 0.3 | 3.1 | 0.3 | 0.3 | 164 | 29 | 0.68 |
| Example 130 | 3.3 | A | 240 | 0 | 240 | 2 | 0.2 | 3.1 | 0.2 | 0.3 | 172 | 70 | 0.91 |

As shown in Table 1, the cellulose acylate films produced according to the production method of the invention are excellent in Re expression and have a low haze value, and have a low micro-slow axis angle distribution of the film as compared with the cellulose acylate films produced according to the production method not falling within the scope of the invention. For example, as is obvious from the comparison between Examples 101 to 106 and Comparative Example 101, when the starting film is previously processed to have a haze value of at least 0.4% according to the invention, then the retardation expression in the film processed for heat treatment under the same condition can be significantly enhanced and can be decreased the micro-slow axis angle distribution of the film to the range of the invention. This is obvious also from the comparison between Examples 113 to 114 and Comparative Example 105.

On the other hand, when the film having a haze value of less than 0.4% was neither stretched nor heat-treated, then the retardation of the film was still low and the micro-slow axis angle distribution of the film did not fall within the scope of the invention (Comparative Example 102). Further, when the heat treatment temperature was lower than the lowermost limit in the invention, then the retardation expression of the film was low and the haze thereof was high, and the film was not applicable to optical films. Though the micro-slow axis angle distribution of the film fell within the scope of the invention, the haze of the film did not fall within the scope of the invention in Comparative Example 103 and Comparative Example 106. When the heat treatment temperature was higher than the uppermost limit in the invention, the film was greatly colored or cracked and was no more in use (Comparative Example 104).

In Examples and Comparative Examples in Table 1, all the films except Comparative Films 102, 103 and 106 had a quantity of crystallization heat of not more than 2.0 J/g and had a quantity of melting heat (ΔHm) of not less than 0 J/g.

Further, from Table 1, it is known that, when a film of a cellulose acylate having a specific degree of substitution was pre-stretched under a specific condition, then a film containing fine particles in an amount of from 0 to 7.5% added thereto relative to the cellulose acylate and having a haze value of at least 1.5%, which is favorably used in the production method of the invention, could be obtained (Examples 104 to 122 and 127 to 130).

(Contact with Organic Solvent)

In Table 1, the cellulose acylate films of Examples 119, 123 and 124 were, after the re-stretching step, further processed as follows: A coating liquid A mentioned below was applied to the surface of the film which was on the air-interface side thereof in its production, using a wire bar coater #6, then dried at 70° C. for 180 seconds, and was rolled up as a roll of 3900-m film. These are film samples of Examples 201, 202 and 203. The film samples of Examples 201 to 203 were visually checked for the outward appearance thereof, and it was confirmed that all the films had excellent surface smoothness and transparency and they were favorably applicable to optical films.

Coating Liquid A:

Acetone/cyclohexane=60/40.

(Contact with Water Vapor)

In Table 1, the cellulose acylate film of Examples 119, 123 and 124 was, after the re-stretching step, processed as follows: The film was pre-heated at 120° C., then its conveyance tension was set at 60 N/m, and the film was contacted with water vapor conditioned at 106° C. and a relative humidity of 70% for 1 minute, and thereafter dried in a drying zone at 130° C. for 2 minutes, and rolled up as a roll of 3900-m film. These films are Examples 251, 252 and 253.

### (Wet Heat Durability Test)

The cellulose film of Examples 119, 123, 124 and 251 to 253 was tested for durability at 60° C. and a relative humidity of 90′ for 24 hours, and then its Rth was measured according to the above-mentioned method. The films were compared with each other in point of the Rth change before and after the durability test. In Examples 251 to 253, the Re fluctuation width (Re after durability test−Re before durability test) and the Rth fluctuation width (Rth after durability test−Rth before durability test) both lowered to from 5 to 70% as compared with the films of Examples 119, 123 and 124; and this confirms the retardation change after the durability test.

### <<2>> Production and Evaluation of Polarizer

### (Production of Polarizer)

### 1) Saponification of Film:

The films produced in Examples, Comparative Examples, Fujitac TF80UL (by FUJIFILM, hereinafter referred to as “Tac A”) and Fujitac TD80UL (by FUJIFILM, hereinafter referred to as “Tac B”) were dipped in an aqueous NaOH solution (1.5 mol/L) (saponification solution) conditioned at 55° C. for two minutes, then the films were rinsed with water, then dipped in an aqueous sulfuric acid solution (0.05 mol/L) for 30 seconds, and further led to pass through a rinsing bath. Water was removed from them through treatment with an air knife three times, and after water removal, these were left in a drying zone at 70° C. for 15 seconds and dried therein. The process thus gave saponified films.

### 2) Formation of Polarizing Film:

According to Example 1 in JP-A 2001-141926, a film was stretched in the machine direction between two pairs of nip rolls rotating at a different peripheral speed, thereby giving a polarizing film having a thickness of 20 μm.

### 3) Lamination:

The thus-obtained polarizing film was combined with any two of the above-saponified films (film A and film B combined as in Table 2 below). The saponified surface of each film was disposed to face the polarizing film. The polarizing film was sandwiched between the saponified films and stuck together, using an aqueous 3% PVA solution (Kuraray's PVA-117H) serving as an adhesive, in such a manner that the polarizing axis could be perpendicular to the machine direction of the film according to a roll-to-roll process thereby giving a polarizer.

### (Evaluation of Polarizer)

### 1) Initial Degree of Polarization:

The degree of polarization of the polarizer was determined according to the method mentioned in the above. The results are shown in Table 2 below.

2) Degree of Polarization after aged 1:

The polarizer was stuck to a glass sheet with an adhesive with its film A facing to the glass sheet, and left under a condition of 60° C. and a relative humidity of 95% for 500 hours. After thus left, the degree of polarization of the polarizer (degree of polarization after aged) was determined according to the above-mentioned method. The results are shown in Table 2.

3) Degree of Polarization after aged 2:

The polarizer was stuck to a glass sheet with an adhesive with its film A facing to the glass sheet, and left under a condition of 90° C. and a relative humidity of 0% for 500 hours. After thus left, the degree of polarization of the polarizer (degree of polarization after aged) was determined according to the above-mentioned method. The results are shown in Table 2.

TABLE 2

| | | | Initial | Degree of | Degree of |
|---|---|---|---|---|---|
| | | | Degree of | Polarization after | Polarization after |
| | Film A | Film B | Polarization [%] | aged 1 [%] | aged 2 [%] |
| Example 301 | Example 101 | Tac A | 99.9 | 99.9 | 99.9 |
| Example 302 | Example 102 | Tac A | 99.9 | 99.9 | 99.9 |
| Example 303 | Example 103 | Tac A | 99.9 | 99.9 | 99.9 |
| Example 304 | Example 104 | Tac A | 99.9 | 99.9 | 99.9 |
| Example 305 | Example 105 | Tac A | 99.9 | 99.9 | 99.9 |
| Example 306 | Example 106 | Tac A | 99.9 | 99.9 | 99.9 |
| Example 307 | Example 107 | Tac A | 99.9 | 99.9 | 99.9 |
| Example 308 | Example 108 | Tac A | 99.9 | 99.9 | 99.9 |
| Example 309 | Example 109 | Tac A | 99.9 | 99.9 | 99.9 |
| Example 310 | Example 110 | Tac A | 99.9 | 99.9 | 99.9 |
| Example 311 | Example 111 | Tac A | 99.9 | 99.9 | 99.9 |
| Example 312 | Example 112 | Tac A | 99.9 | 99.9 | 99.9 |
| Example 313 | Example 113 | Tac A | 99.9 | 99.9 | 99.9 |
| Example 314 | Example 114 | Tac A | 99.9 | 99.9 | 99.9 |
| Example 315 | Example 115 | Tac A | 99.9 | 99.9 | 99.9 |
| Example 316 | Example 116 | Tac A | 99.9 | 99.9 | 99.9 |
| Example 317 | Example 117 | Tac A | 99.9 | 99.9 | 99.9 |
| Example 318 | Example 118 | Tac A | 99.9 | 99.9 | 99.9 |
| Example 319 | Example 119 | Tac A | 99.9 | 99.9 | 99.9 |
| Example 320 | Example 120 | Tac A | 99.9 | 99.9 | 99.9 |
| Example 321 | Example 121 | Tac A | 99.9 | 99.9 | 99.9 |
| Example 322 | Example 122 | Tac A | 99.9 | 99.9 | 99.9 |
| Example 323 | Example 123 | Tac A | 99.9 | 99.9 | 99.9 |
| Example 324 | Example 124 | Tac A | 99.9 | 99.9 | 99.9 |
| Example 325 | Example 125 | Tac A | 99.9 | 99.9 | 99.9 |
| Example 326 | Example 126 | Tac A | 99.9 | 99.9 | 99.9 |
| Example 327 | Example 127 | Tac A | 99.9 | 99.9 | 99.9 |
| Example 328 | Example 128 | Tac A | 99.9 | 99.9 | 99.9 |
| Example 329 | Example 129 | Tac A | 99.9 | 99.9 | 99.9 |
| Example 330 | Example 130 | Tac A | 99.9 | 99.9 | 99.9 |
| Example 331 | Example 103 | Example 103 | 99.9 | 99.9 | 99.9 |
| Example 401 | Example 201 | Tac B | 99.9 | 99.9 | 99.9 |
| Example 402 | Example 202 | Tac B | 99.9 | 99.9 | 99.9 |
| Example 403 | Example 203 | Tac B | 99.9 | 99.9 | 99.9 |
| Example 404 | Example 251 | Tac B | 99.9 | 99.9 | 99.9 |
| Example 405 | Example 252 | Tac B | 99.9 | 99.9 | 99.9 |
| Example 406 | Example 253 | Tac B | 99.9 | 99.9 | 99.9 |
| Comparative | Comparative | Tac A | 99.9 | 99.9 | 99.9 |
| Example 301 | Example 101 | | | | |
| Comparative | Comparative | Tac A | 99.9 | 99.9 | 99.9 |
| Example 302 | Example 102 | | | | |
| Comparative | Comparative | Tac A | 99.9 | 99.9 | 99.9 |
| Example 303 | Example 103 | | | | |
| Comparative | Comparative | Tac A | 99.9 | 99.9 | 99.9 |
| Example 304 | Example 105 | | | | |
| Comparative | Comparative | Tac A | 99.9 | 99.9 | 99.9 |
| Example 305 | Example 106 | | | | |

As in Table 2, all the polarizers were good, as having a degree of polarization of 99.9%.

### 4) Evaluation of Adhesiveness:

The polarizers of Examples 401 to 403, 319, 323 and 324 were tested as follows: Using a cutter guide having a slit distance of 1 mm, the film was cut to form 100 cross-cuts on its surface. An adhesive tape was stuck to the cut surface of the film, and rubbed with a plastic stick covered one-fold with gauze, whereby they were completely adhered to each other. Next, the adhesive tape was peeled off vertically, and the tape-peeled surface of the film was visually checked. This peeling test was repeated 10 times, and all the 1000 cross-cuts of the tested samples were checked. The polarizer of Examples 401 to 403 did not peel at all; but in the polarizer of Examples 319, 323 and 324, one cross-cut peeled. This confirms excellent adhesiveness of the tested samples.

The cellulose acylate films of Examples 251 to 253 were processed according to the above mentioned contact with organic solvent process of Example 201, and then polarizers were produced with the films obtained. The adhesiveness of the polarizers obtained were tested, and it was confirmed that all the polarizers had improved adhesiveness compared to the polarizers of Examples 319, 323 and 324.

### <<3>> Evaluation in Mounting on IPS-Mode Liquid Crystal Display Device

The polarizer of Examples 319, 401 and 404 was incorporated into an IPS-mode liquid crystal display device (37-inch high-definition liquid crystal TV monitor (37Z2000), by Toshiba) in place of the original polarizer therein, and the device was checked for the visibility. As a result, the device secured sufficient viewing angle compensation and had good visibility. As opposed to this, in case where the polarizer of Comparative Examples 301 to 304 was incorporated, the viewing angle compensation was insufficient, and in particular, the light leakage in oblique directions was strong.

A panel with the polarizer of Comparative Examples 301 and 302 incorporated therein, and a panel with the polarizer of Example 319 incorporated therein were lined up and put together, and compared with each other in point of the visibility on the panel front surface at the time of black level of display. The panel with the polarizer of Comparative Examples 301 and 302 incorporated therein showed significant light leakage on the entire surface thereof.

### <<4>> Evaluation in Mounting on VA-Mode Liquid-Crystal Display Device

The polarizer of Examples 323, 324, 402, 403, 405 and 406 was incorporated into a VA-mode liquid-crystal display device (37-inch high-definition liquid-crystal TV monitor (LC-37GX3W), by Sharp) in place of the original polarizer therein, and the device was checked for the visibility. As a result, the device secured sufficient viewing angle compensation and had good visibility. Using a contrast meter (EZ-Contrast 160D, by ELDIM), the front contrast of the device was measured at 25° C. and a relative humidity of 60%, and the front contrast thereof was seen to be enhanced. As opposed to this, in case where the polarizer of Comparative Examples 305 was incorporated, the viewing angle compensation and the visibility in the oblique direction were good, but the front contrast was lowered.

What is claimed is:

1. A method for producing a cellulose acylate film, comprising heat-treating a cellulose acylate film having a haze, at a temperature T (unit, ° C.) satisfying the condition of the following formula (I):
Tc≦T<Tm₀ (I)
wherein Tc means the crystallization temperature (unit, ° C.) of the cellulose acylate film before the heat treatment;
Tm₀ means the melting point (unit, ° C.) of the cellulose acylate film before the heat treatment.

2. The method for producing a cellulose acylate film according to claim 1, wherein the haze-having cellulose acylate film contains fine particles in an amount of from 0 to 7.5 by mass relative to the cellulose acylate.

3. The method for producing a cellulose acylate film according to claim 1, further comprising pre-stretching a cellulose acylate film to prepare the cellulose acylate film having a haze.

4. The method for producing a cellulose acylate film according to claim 1, wherein the heat treatment is attained until the haze value of the cellulose acylate film lowers by at least 0.050% relative to the haze value of the cellulose acylate film before the heat treatment.

5. A cellulose acylate film having a quantity of crystallization heat of at most 2.0 J/g, a quantity of melting heat (ΔHm) of more than 0 J/g, and a micro-slow axis angle distribution of at most 3°.

6. The cellulose acylate film produced according to the production method of claim 1.

7. The cellulose acylate film according to claim 6, having a quantity of crystallization heat of at most 2.0 J/g, a quantity of melting heat (ΔHm) of more than 0 J/g, and a micro-slow axis angle distribution of at most 3°.

8. A cellulose acylate film containing fine particles in an amount of from 0 to 7.5% by mass added thereto relative to the cellulose acylate and having a haze value of at least 1.5%.

9. The cellulose acylate film according to claim 8, having a haze value of from 1.5% to less than 25%.

10. A retardation film having at least one cellulose acylate film according of claim 5.

11. A polarizer having at least one cellulose acylate film according of claim 5.

12. A liquid crystal display device having at least one cellulose acylate film of claims 5.
